(19) United States
(12) Patent Application Publication
(10) Pub. No.: US 2026/0148429 A1
(43) Pub. Date: May 28, 2026

(54) IMAGE MANIPULATION WITH SPARSE CONTROL

(71) Applicant: ADOBE INC., SAN JOSE, CA (US)

(72) Inventors: Jindong Jiang, Highland Park, NJ (US); Zhifei Zhang, San Jose, CA (US); Jianming Zhang, Cupertino, CA (US); Qing Liu, Santa Clara, CA (US); Yilin Wang, Sunnyvale, CA (US); Zhe Lin, Clyde Hill, WA (US)

(21) Appl. No.: 18/958,191

(22) Filed: Nov. 25, 2024

(51) Int. Cl. G06T 11/00; G06T 3/00

(52) U.S. Cl. CPC G06T 11/00; G06T 3/00

(57) ABSTRACT

A method, apparatus, non-transitory computer readable medium, and system for image processing include obtaining an input image and a modification input, wherein the input image depicts an object and the modification input indicates a change to the object. A feature map is generated, and the feature map represents the object based on the input image. The feature map is transformed to obtain a transformed feature map based on the modification input. The transformed feature map represents the change to the object. A synthetic image is generated, using an image generation model, based on the input image and the transformed feature map. The synthetic image depicts the change to the object.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image processing. Embodiments of the present disclosure include an image processing apparatus that obtains an input image and generates a synthetic image that depicts a change to a location of a part of the object in the input image. The image processing apparatus can alter size, pose, orientation, viewpoint, and/or shape of an object in the input image following the change to location of a part of the object (e.g., dragging one or more handle points of the object). By tracking a corresponding set of key points on an object at different views, an image generation model (e.g., including a control network and a diffusion model) is trained to rearrange the object features in a way that the rearrangement follows the target object shape/viewpoint. At inference time, a user drags one or more handle points on an object and the image generation model outputs a synthetic image that changes the shape, size, pose and/or structure of the object.

A method, apparatus, non-transitory computer readable medium, and system for image generation are described. One or more embodiments of the method, apparatus, non-transitory computer readable medium, and system include obtaining an input image and a modification input, wherein the input image depicts an object and the modification input indicates a change to the object; generating a feature map representing the object based on the input image; transforming the feature map to obtain a transformed feature map based on the modification input, wherein the transformed feature map represents the change to the object; and generating, using an image generation model, a synthetic image based on the input image and the transformed feature map, wherein the synthetic image depicts the change to the object.

A method, apparatus, non-transitory computer readable medium, and system for image generation are described. One or more embodiments of the method, apparatus, non-transitory computer readable medium, and system include obtaining a training set including a training image and a ground-truth image, wherein the training image depicts an object and the ground-truth image depicts a change to the object; generating a feature map representing the object based on the training image; transforming the feature map to obtain a transformed feature map, wherein the transformed feature map represents the change to the object; and training, using the training set, an image generation model to generate a synthetic image based on the training image and the transformed feature map, wherein the synthetic image depicts the change to the object.

An apparatus, system, and method for image generation are described. One or more embodiments of the apparatus, system, and method include a memory component; a processing device coupled to the memory component, where the processing device is configured to perform operations comprising: obtaining an input image and a modification input, wherein the input image depicts an object and the modification input indicates a change to the object; generating a feature map representing the object based on the input image; transforming the feature map to obtain a transformed feature map based on the modification input, wherein the transformed feature map represents the change to the object; and generating, using an image generation model, a synthetic image based on the input image and the transformed feature map, wherein the synthetic image depicts the change to the object.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of image editing based on a drag command according to aspects of the present disclosure.

FIG. 4 shows an example of image editing according to aspects of the present disclosure.

FIG. 5 shows an example of key points in images according to aspects of the present disclosure.

FIG. 6 shows an example of a method for image generation according to aspects of the present disclosure.

FIG. 7 shows an example of an image processing apparatus according to aspects of the present disclosure.

FIGS. 8 and 9 show examples of a machine learning model according to aspects of the present disclosure.

FIG. 10 shows an example of a guided diffusion model according to aspects of the present disclosure.

FIG. 11 shows an example of a U-Net architecture according to aspects of the present disclosure.

FIG. 12 shows an example of a diffusion process according to aspects of the present disclosure.

FIG. 13 shows an example of an image generation model comprising a control network according to aspects of the present disclosure.

FIG. 14 shows an example of a control network of an image generation model according to aspects of the present disclosure.

FIGS. 15 and 16 show examples of methods for image generation according to aspects of the present disclosure.

FIGS. 17-19 show examples of masks and synthetic images according to aspects of the present disclosure.

FIG. 20 shows an example of image modification according to aspects of the present disclosure.

FIG. 21 shows an example of a method for training an image generation model according to aspects of the present disclosure.

FIG. 22 shows an example of a training dataset according to aspects of the present disclosure.

FIG. 23 shows an example of a method for training a diffusion model according to aspects of the present disclosure.

FIG. 24 shows an example of a step-by-step procedure for training a machine learning model according to aspects of the present disclosure.

FIG. 25 shows an example of a computing device for image processing according to aspects of the present disclosure.

### DETAILED DESCRIPTION

The present disclosure describes systems and methods for image processing. Embodiments of the present disclosure include an image processing apparatus that obtains an input image and generates a synthetic image that depicts a change to a location of a part of the object in the input image. The image processing apparatus can alter size, pose, orientation, viewpoint, and/or shape of an object in the input image following the change to location of a part of the object (e.g., dragging one or more handle points of the object). By tracking a corresponding set of key points on an object at different views, an image generation model (e.g., including a control network and a diffusion model) is trained to rearrange the object features in a way that the rearrangement follows the target object shape/viewpoint. At inference time, a user drags one or more handle points on an object and the image generation model outputs a synthetic image that changes the shape, size, pose and/or structure of the object.

Diffusion models are a class of generative neural networks that can be trained to generate new data with features similar to features found in training data. Diffusion models can be used in image synthesis, image completion tasks, etc. Conventional models such as object warping fail to take into account shadow and light harmonization. Some object editing models use masks, but masks are difficult for users to draw and edit.

Embodiments of the present disclosure include an image processing apparatus that obtains an input image and a modification input, where the input image depicts an object, and the modification input indicates a change to a location of a part of the object. The image processing apparatus generates a feature map representing the part of the object based on the input image and transforms the feature map to obtain a transformed feature map based on the modification input. The transformed feature map represents the change to the location of the part of the object. An image generation model generates a synthetic image based on the input image and the transformed feature map, wherein the synthetic image depicts the change to the location of the part of the object.

In some examples, target object manipulation involves scaling, relocation, rotation, stretching, local dragging, etc. The object manipulation is initiated and performed by sparse user control, e.g., dragging on screen with one or two handle points. Unlike conventional models that simply warp an object, the image processing apparatus described in the present disclosure can harmonize lighting, shadow, and geometry/viewpoint of the object. The image processing apparatus unifies heroization and manipulation in a unified model, achieving photo realistic object manipulation. Therefore, users can edit an object by dragging without incurring extra efforts on editing shadow, lighting, color/tone of the object to make it visually consistent to the background.

In some embodiments, the image processing apparatus performs mask-guided image inpainting using a control network (i.e., a mask guidance model). In some cases, the guidance mask has a different shape from a target object which is fed to an image encoder. At denoising, a diffusion model takes a union region of the guidance mask and the input object while considering optical influence of the object. This way, the image generation model can inpaint related regions (e.g., generating or removing shadows). With mask guidance, the target object follows the mask shape while preserving the identity of the input object fed to the image encoder. In some cases, the dragging model and the mask guidance model can be trained in a unified framework to achieve mask and dragging control at the same time.

The present disclosure describes methods of object editing, inpainting, and synthesis using dragging, mask guidance, or its combination. By learning a correspondence between original key points and transformed key points (and their feature maps), the model can generate a more accurate depiction of a target object based on a modification input (e.g., user dragging handle points). Additionally, mask-guided generation takes into account optical influence such as shadow and light harmonization by generating an augmented mask during the denoising process. The quality and accuracy of synthesized images are increased.

The present disclosure describes systems and methods that improve on conventional image generation models by increasing the accuracy of a target object generated in a synthesized image. For example, users can use the machine learning model described in the present disclosure to modify the scale, location, pose, orientation, view and so on related to an object in an input image. Embodiments of the present disclosure achieve this increased accuracy by identifying a set of key points of the object to be edited and perform targeted feature transformation to preserve background and object identity. The transformed key points (as guidance) are fed to a control network. The machine learning model provides a heightened level of precision and refinement in the field of image inpainting and object editing.

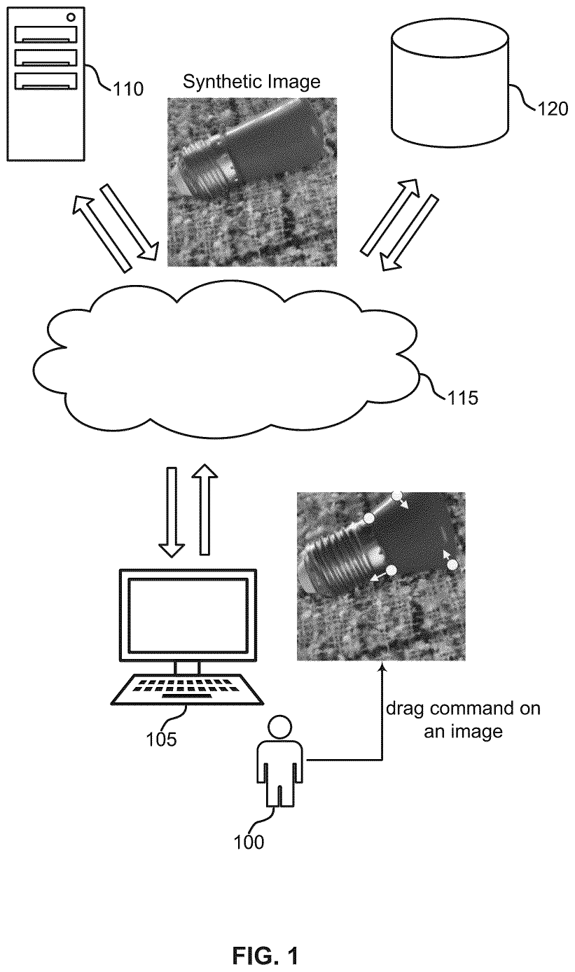

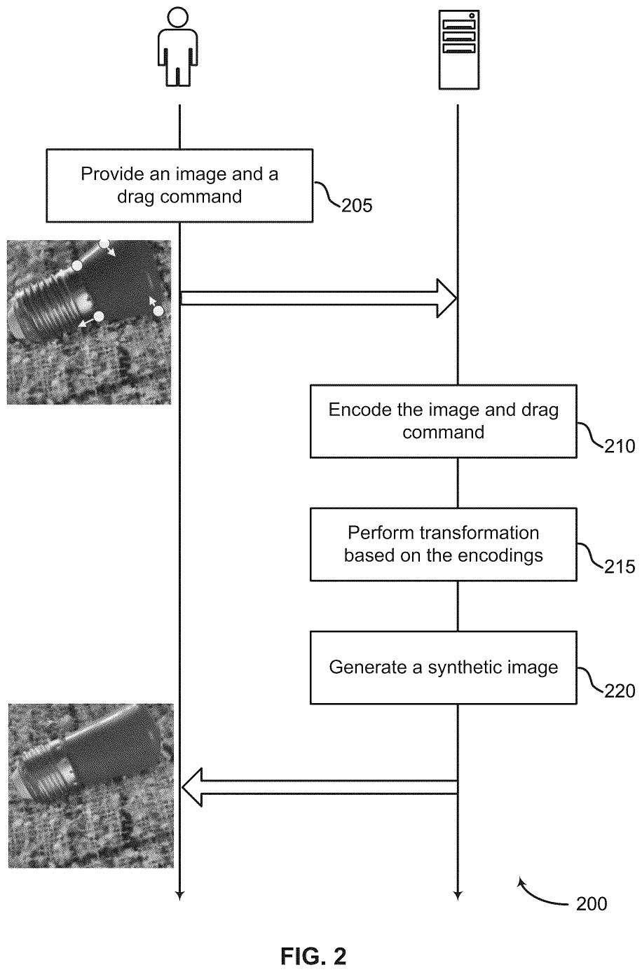

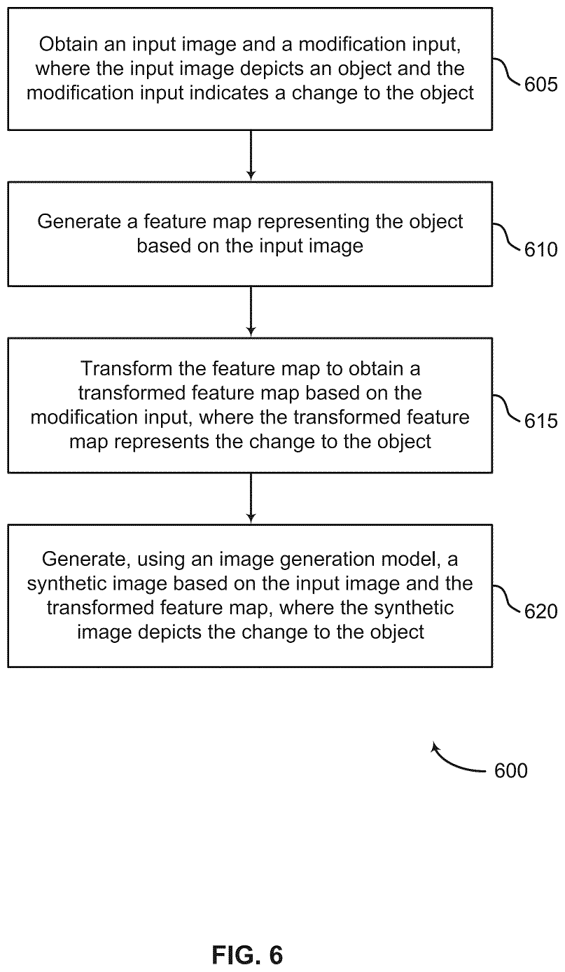

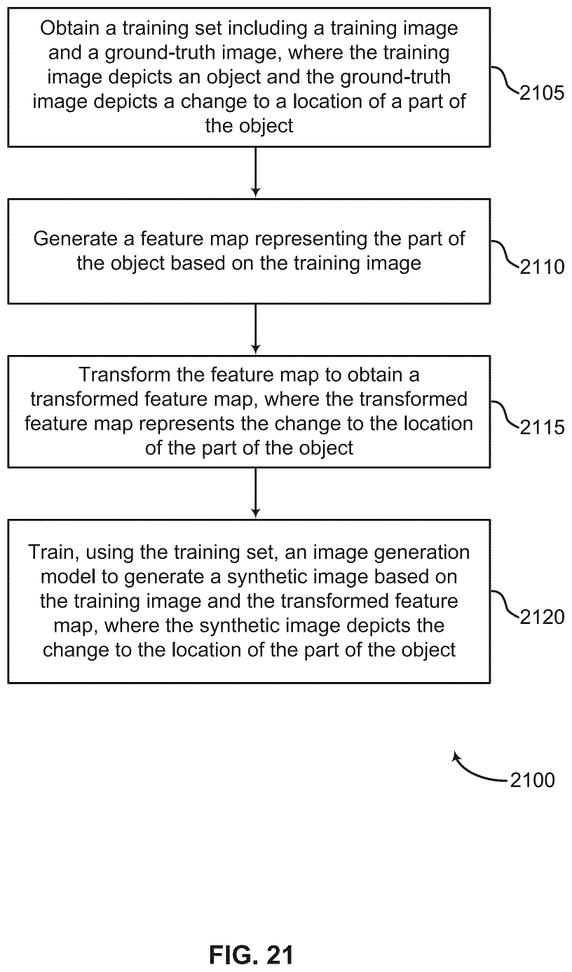

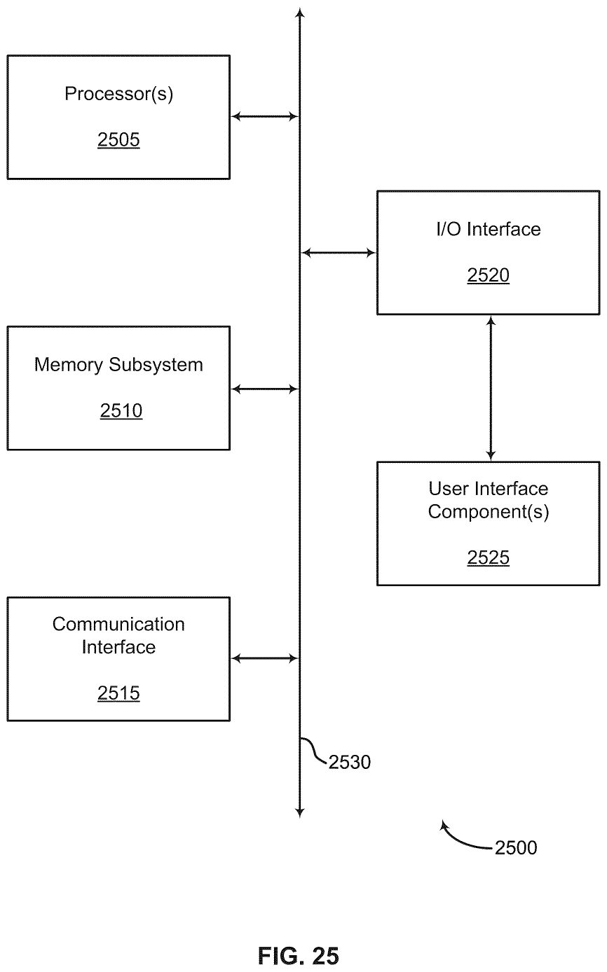

Embodiments of the present disclosure have applications in image generation, image inpainting, and object editing. Examples of application in image generation context are provided with reference to FIGS. 2-5. Details regarding the architecture of an example image generation system are provided with reference to FIGS. 1 and 7-14. Details regarding the image generation process are provided with reference to FIGS. 6 and 15-16. Details regarding an example of training a machine learning model are provided with reference to FIGS. 21-24. Details regarding a computing device for image processing are provided with reference to FIG. 25.

### Image Processing

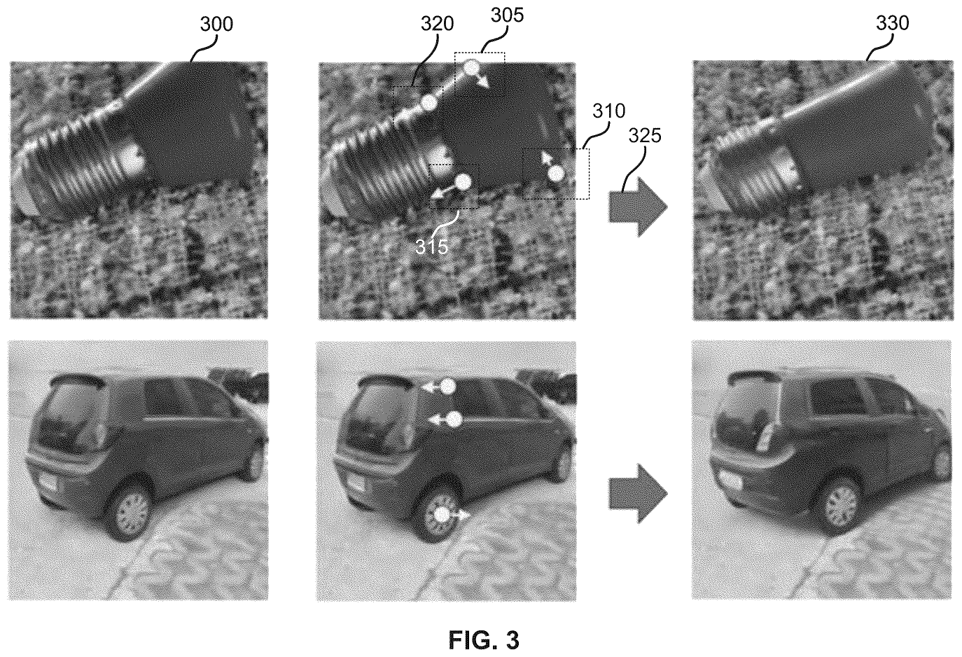

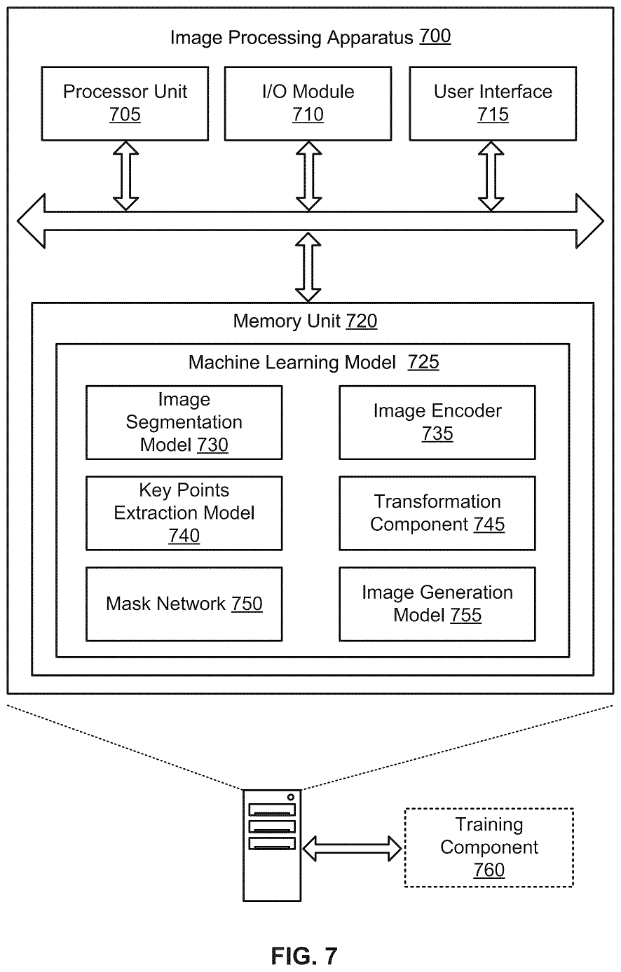

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 3 and 7.

In an example shown in FIG. 1, an input image is provided by user 100. The input image includes an object (a light bulb) that user 100 wants to adjust. For example, user 100 wants to adjust the shape, orientation, and geometry of the light bulb by dragging one or more handle points located on the object. There are four handle points associated with the light bulb. A drag input that changes a location of the handle point is transmitted to the image processing apparatus 110, e.g., via user device 105 and cloud 115. The drag input may be viewed as an example of modification input.

The image processing apparatus 110 determines the change to the location of the part of the object based on the drag input. The image processing apparatus 110 generates, using an image generation model, a synthetic image based on the input image and the modification input (e.g., the drag input obtained from dragging the one or more handle points). In this example, the synthetic image depicts the change to the location of the part of the object. Image processing apparatus 110 returns the synthetic image to user 100 via cloud 115 and user device 105. The synthetic image depicts the same scene. The light bulb in the synthetic image is thinner and its head portion looks longer compared to the object in the input image.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some cases, the user 100 applies a drag command on an image. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image processing apparatus 110 includes a computer-implemented network comprising an image segmentation model, an image encoder, a key points extraction model, a transformation component, a mask network, and an image generation model (such as a diffusion U-Net). Image processing apparatus 110 may also include a processor unit, a memory unit, an I/O module, and a user interface. A training component may be implemented on an apparatus other than image processing apparatus 110. The training component is used to train a machine learning model (as described with reference to FIG. 7). Additionally, image processing apparatus 110 can communicate with database 120 via cloud 115. In some cases, the architecture of the machine learning model is also referred to as a network or a network model. Further detail regarding the architecture of image processing apparatus 110 is provided with reference to FIGS. 7-14. Further detail regarding the operation of image processing apparatus 110 is provided with reference to FIGS. 2, 6 and 15-16.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for conditional media generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides an image and a drag command. In some cases, the operations of this step refer to, or may be performed by, a user as described with reference to FIG. 1. In some cases, an image depicts one or more objects. In an example shown in FIG. 2, an object in the image is a lightbulb. Here, a modification input refers to the drag command applied to the lightbulb. The modification input includes information indicating a change to an object, for example, a change to a location of a part of the object. In some cases, the drag command indicates a relocation of multiple different parts of the object.

In this example, the drag command (or drag input) is represented by a set of handle points (circles with arrowheads) overlayed onto the image of the lightbulb. The circle of a handle point indicates the location of the object (e.g. a corner of the lightbulb) to be transformed, and the arrow of the handle point indicates the intended transformation (e.g. moving the corner of the lightbulb to the location/direction indicated by the arrow). The location of the object to be transformed is indicated through a user manipulating a handle point. The drag command enables sparse control from user 100 as described with reference to FIG. 1. In some examples, the drag command is obtained by moving a finger or dragging a mouse. The handle point is dragged (or moved) to a different location than its starting location.

At operation 210, the system encodes the image and the drag command to obtain an image encoding. In some cases, the operations of this step refer to, or may be performed by, an image processing apparatus as described with reference to FIGS. 1, 3, and 7. In some cases, the image and the drag command are encoded into an embedding space (e.g. represented by token(s)). The embedded image and drag command are in a format for processing using a machine learning model. In this example, the image of the lightbulb and the drag command are encoded.

At operation 215, the system performs transformation based on the image encoding. In some cases, the operations of this step refer to, or may be performed by, an image processing apparatus as described with reference to FIGS. 1, 3, and 7. In some cases, the encoded image is modified to represent an object in the encoded image with relation to the drag command/modification input. The object in the encoded image is modified based on the transformation of the embedding of the image, and locations of the object are moved by the drag command. In this example, the encoded representation of the lightbulb is transformed according to the encoded drag command.

At operation 220, the system generates a synthetic image. In some cases, the operations of this step refer to, or may be performed by, an image processing apparatus as described with reference to FIGS. 1, 3, and 7. In some cases, a trained image generation model generates the synthetic image based on the input image and the drag command. The synthetic image depicts the same object from the input image that has been transformed according to the drag command. For example, the object in the synthetic image has parts of the object which are in different locations than the object in the input image (hence changing the size, scale, pose, viewpoint of the object). The synthetic image maintains the same background as in the input image and preserves object identity.

In the above example shown in FIG. 2, the synthetic image depicts a modified lightbulb having different size and scale compared to the original object. Portions of the lightbulb have been moved (e.g., squeezed, extended) according to the drag command. For example, the base of top portion of the lightbulb is moved closer to the bottom of the lightbulb, and the width of the top portion of the lightbulb is decreased. The background in the synthetic image and object identity of the lightbulb are visually consistent with those of the input image.

FIG. 3 shows an example of image editing based on a drag command according to aspects of the present disclosure. The example shown includes input image 300, first handle point 305, second handle point 310, third handle point 315, fourth handle point 320, image processing apparatus 325, and synthetic image 330. Image processing apparatus 325 is an example of, or includes aspects of, the corresponding element described with reference to FIGS. 1 and 7.

Referring to FIG. 3, an image processing apparatus 325 (as described with reference to FIGS. 7-9) takes an input image 300 and a modification input which depicts a change in location of one or more parts of an object in input image 300 (e.g., a lightbulb). In some examples, the modification input involves applying a drag input to a handle point of input image 300 (e.g. first handle point 305, second handle point 310, third handle point 315, and fourth handle point 320). An image processing apparatus 325 takes input image 300 and the modification input (e.g., drag input) as inputs and generates synthetic image 330. The synthetic image 330 depicts an object from input image 300 having the parts of the object indicated by handle points moved according to a respective drag input. For example, a drag input may be represented by the length and direction of an arrow bar of a corresponding handle point. Image processing apparatus 325 generates synthetic image 330 based on the input image 300 and the transformation input (e.g., drag input).

In an example, input image 300 includes a lightbulb object with a patterned background. First handle point 305, second handle point 310, third handle point 315, and fourth handle point 320 are located at four corners of the upper portion of the lightbulb object, respectively. Image processing apparatus 325 receives a modification input (e.g., a user feeding drag input to the handle points) and generates synthetic image 330 based on the modification input and the input image 300. The synthetic image 330 includes a modified lightbulb which is modified from the original lightbulb object via dragging first handle point 305, second handle point 310, third handle point 315, and fourth handle point 320. The modified lightbulb includes one or more parts at different locations compared to the original object in input image 300.

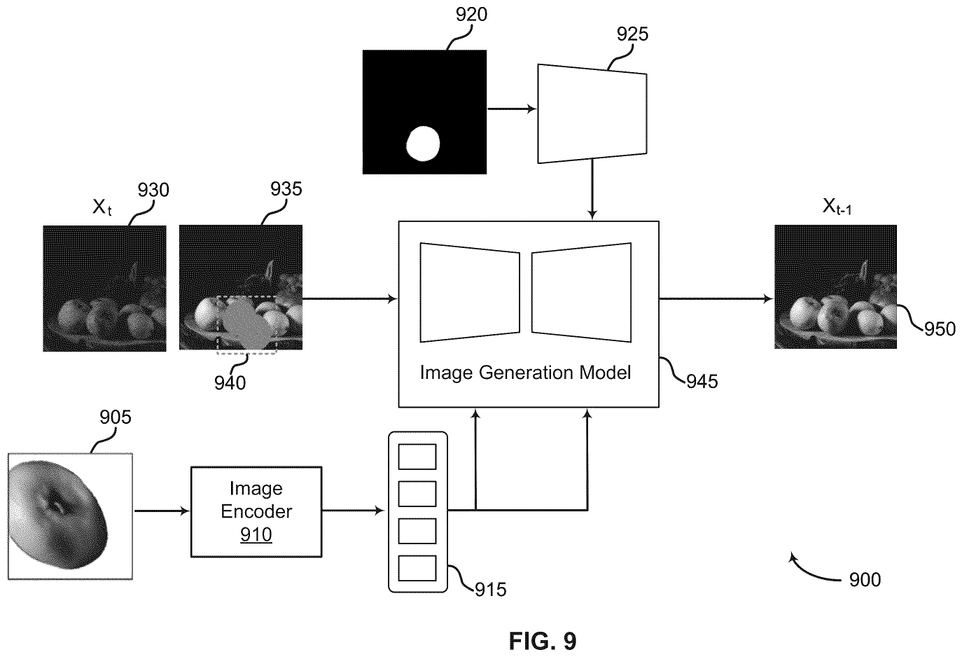

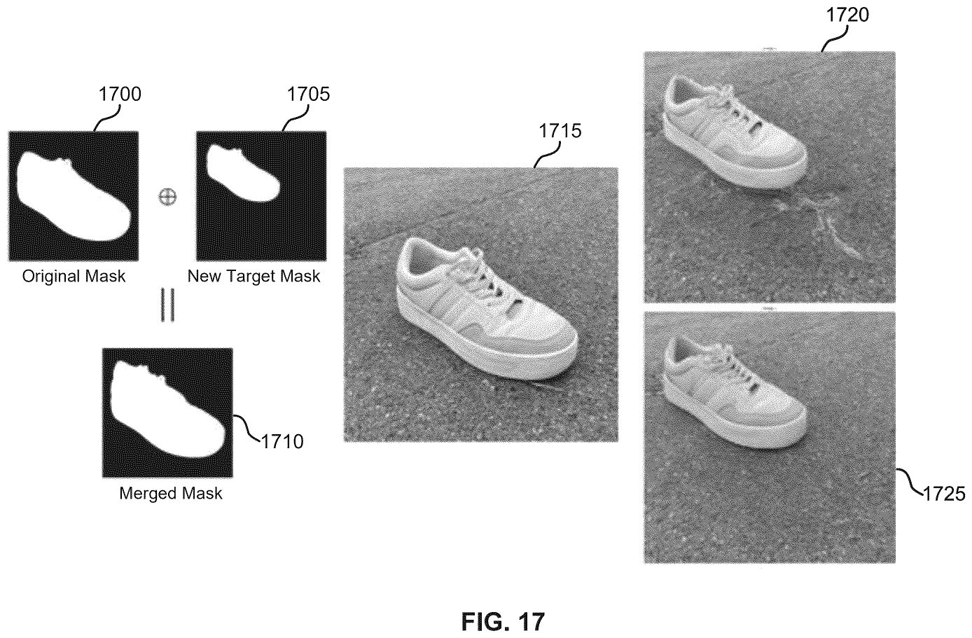

Input image 300 is an example of, or includes aspects of, the corresponding element described with reference to FIG. 9. Synthetic image 330 is an example of, or includes aspects of, the corresponding element described with reference to FIGS. 17-19, and 22.

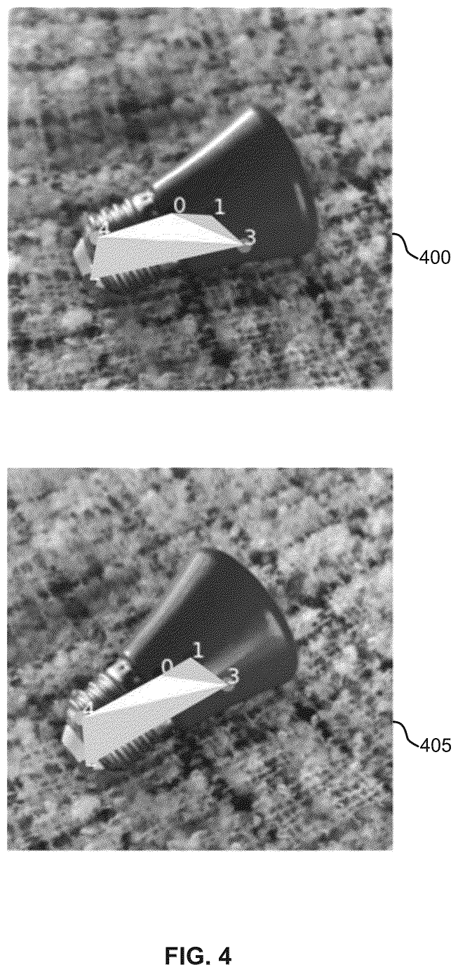

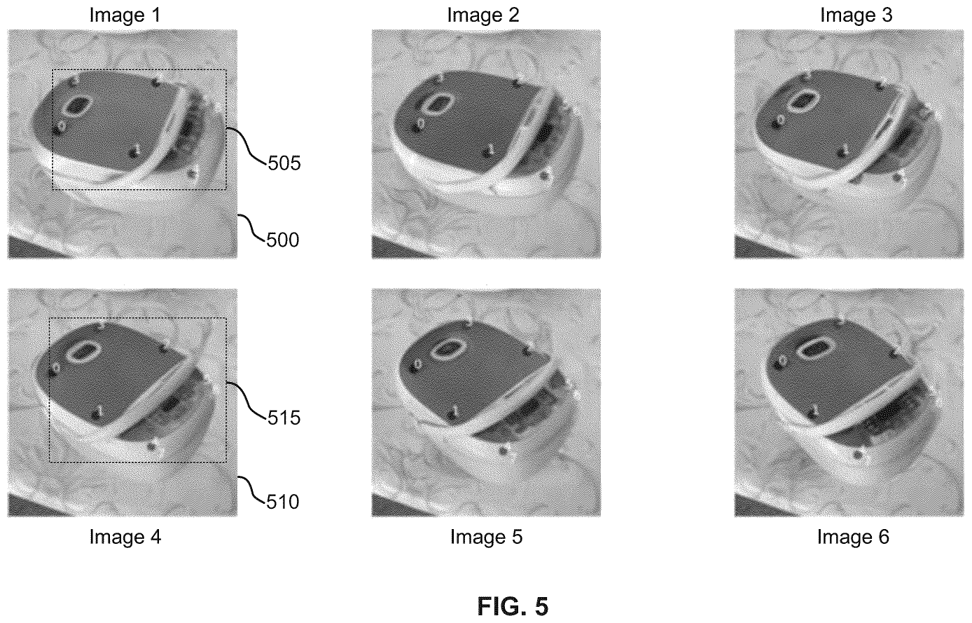

FIG. 4 shows an example of image editing according to aspects of the present disclosure. The example shown includes first image 400 and second image 405. First image 400 is an example of, or includes aspects of, the corresponding element described with reference to FIG. 5. Second image 405 is an example of, or includes aspects of, the corresponding element described with reference to FIG. 5.

In an example shown in FIG. 4, first image 400 includes an original object of an input image. The numbers (“0”, “1”, “3”, “4”) and their locations indicate a set of points that a user has specified. Similarly, second image 405 includes a set of points that represent target location of points that the user has specified. The shaded areas (triangles) in first image 400 and second image 405 show that a transformation component 745 of machine learning model 725 (with reference to FIG. 7) in the backend transforms the features of these triangles to obtain transformed features of the new triangles using feature transformation method(s), e.g., affine transformation.

FIG. 5 shows an example of key points in images according to aspects of the present disclosure. The example shown includes first image 500, second image 510, and other four images. In some examples, a training dataset includes the six images that are used to train a machine learning model as described with reference to FIGS. 7-9. The first image 500 depicts an object in a first object orientation. The second image 510 depicts the same object in a second object orientation (i.e., the object is positioned at a different angle, orientation, viewpoint, etc.).

The first image 500 includes a rice cooking device at a first angle and a patterned background. The second image 510 includes the same rice cooking device at a second angle different from the first angle and a patterned background (same background as first image 500). The object identity and the background are visually consistent between the first image 500 and the second image 510. In one aspect, first image 500 includes a first set of key points 505. The second image 510 includes a second set of key points 515.

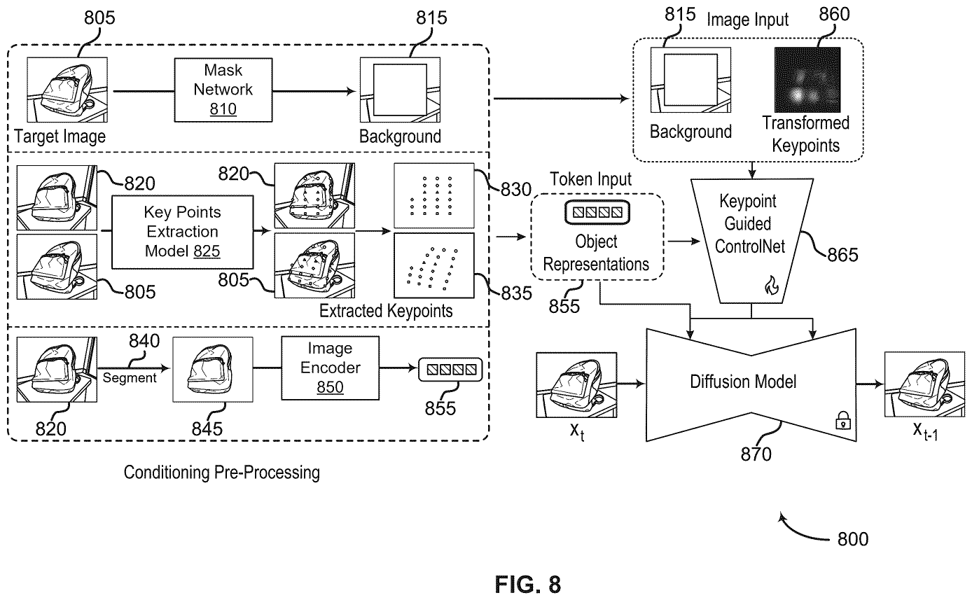

First image 500 is an example of, or includes aspects of, the corresponding element described with reference to FIG. 4. First set of key points 505 is an example of, or includes aspects of, the corresponding element described with reference to FIG. 8. Second image 510 is an example of, or includes aspects of, the corresponding element described with reference to FIG. 4. Second set of key points 515 is an example of, or includes aspects of, the corresponding element described with reference to FIG. 8.

FIG. 6 shows an example of a method 600 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 605, the system obtains an input image and a modification input, where the input image depicts an object and the modification input indicates a change to a location of a part of the object. In some cases, the operations of this step refer to, or may be performed by, a machine learning model as described with reference to FIGS. 7-9.

In some cases, the modification input is represented as a drag command (e.g. a drag input applied to a handle point of the object). The modification input includes information related to moving a handle point of the object towards a target location. The change made to the object includes a change to the object.

At operation 610, the system generates a feature map representing the part of the object based on the input image. In some cases, the operations of this step refer to, or may be performed by, a machine learning model as described with reference to FIGS. 7-9. In some cases, the feature map is generated using a machine learning model. In some cases, the feature map identifies features (e.g. key points) of the object. The part of the object indicated by the modification input corresponds with the feature map.

At operation 615, the system transforms the feature map to obtain a transformed feature map based on the modification input, where the transformed feature map represents the change to the object (e.g., the change to the location of the part of the object). In some cases, the operations of this step refer to, or may be performed by, a transformation component as described with reference to FIG. 7.

In some cases, the feature map transformation occurs in an embedding space. The feature map is transformed to obtain a transformed feature map based on the modification input. The transformed feature map represents the change to the object. In some cases, the transformed feature map corresponds to a set of transformed key points as described in FIG. 8. The transformed feature map (transformed key points) is input to a control network to guide the image generation process.

At operation 620, the system generates, using an image generation model, a synthetic image based on the input image and the transformed feature map, where the synthetic image depicts the change to the object (e.g., the change to the location of the part of the object). In some cases, the operations of this step refer to, or may be performed by, an image generation model as described with reference to FIG. 7.

In some cases, a trained image generation model generates the synthetic image by removing noise from a noisy input. The image generation model includes a diffusion model and a control network. In some examples, the control network takes an input mask as input to provide guidance for the diffusion model. The synthetic image includes the same object (i.e., maintaining object identity), where a part of the object is at a different location in the synthetic image (e.g., different pose, angle, viewpoint, orientation). The overall identity and appearance of the transformed object are visually consistent with the object in the input image.

In FIGS. 1-6, a method, apparatus, non-transitory computer readable medium, and system for image generation are described. One or more embodiments of the method, apparatus, non-transitory computer readable medium, and system include obtaining an input image and a modification input, wherein the input image depicts an object and the modification input indicates a change to the object; generating a feature map representing the object based on the input image; transforming the feature map to obtain a transformed feature map based on the modification input, wherein the transformed feature map represents the change to the object; and generating, using an image generation model, a synthetic image based on the input image and the transformed feature map, wherein the synthetic image depicts the change to the object.

Some examples of the method, apparatus, non-transitory computer readable medium, and system further include identifying a handle point of the object. Some examples further include receiving a drag input that changes a location of the handle point. Some examples further include determining the change to the object based on the drag input. Some examples of the method, apparatus, non-transitory computer readable medium, and system further include generating an object embedding representing the object based on the input image, wherein the synthetic image is generated based on the object embedding.

Some examples of the method, apparatus, non-transitory computer readable medium, and system further include obtaining an input mask indicating a location of the object. Some examples further include masking the input image based on the input mask to obtain a masked image, wherein the synthetic image is generated based on the masked image. Some examples of the method, apparatus, non-transitory computer readable medium, and system further include generating an augmented mask based on the input mask and the modification input, wherein the synthetic image is generated based on the augmented mask.

Some examples of the method, apparatus, non-transitory computer readable medium, and system further include generating an augmented mask based on an optical influence of the object, wherein the synthetic image is generated based on the augmented mask. Some examples of the method, apparatus, non-transitory computer readable medium, and system further include obtaining a noise map. Some examples further include generating control guidance based on the transformed feature map. Some examples further include denoising the noise map based on the input image and the control guidance.

Some examples of the method, apparatus, non-transitory computer readable medium, and system further include identifying a plurality of key points of the input image corresponding to the object, wherein the modification input changes a location of the plurality of key points. In some examples, the image generation model is trained using a training set including a training image and a ground-truth image, wherein the training image depicts a training object and the ground-truth image depicts a change to the training object.

### Network Architecture

FIG. 7 shows an example of an image processing apparatus 700 according to aspects of the present disclosure. The example shown includes image processing apparatus 700, processor unit 705, I/O module 710, user interface 715, memory unit 720, machine learning model 725, and training component 760. Image processing apparatus 700 is an example of, or includes aspects of, the corresponding element described with reference to FIGS. 1 and 3.

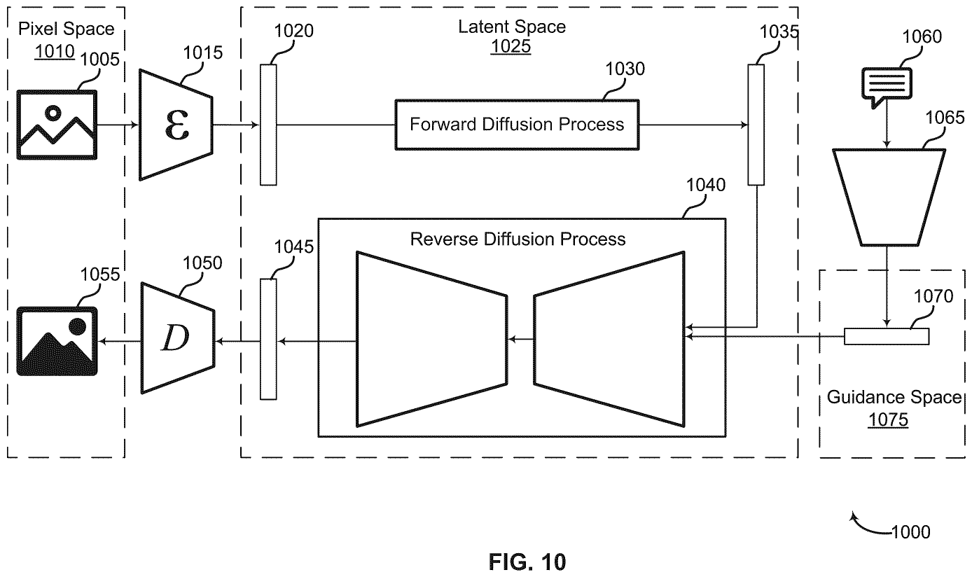

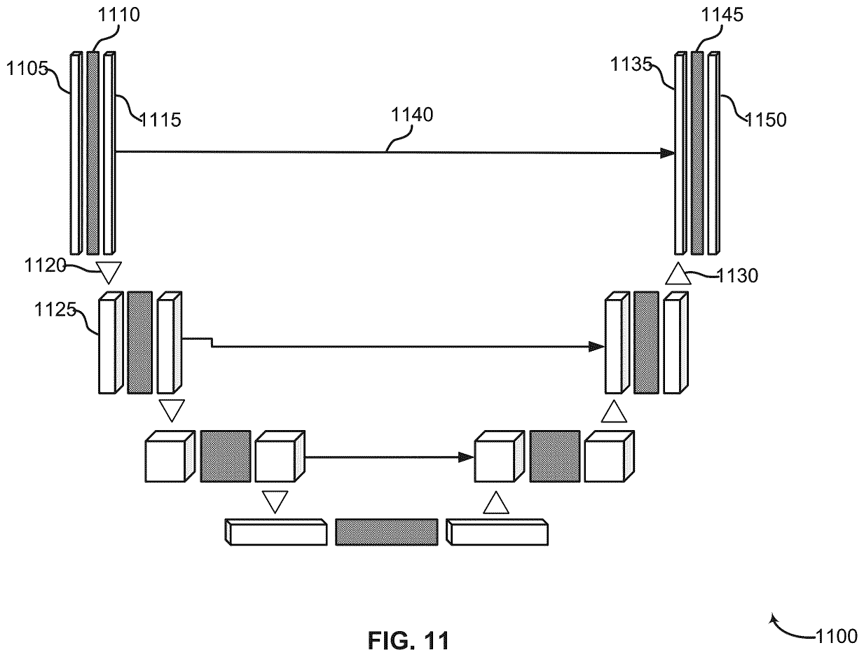

Image processing apparatus 700 may include an example of, or aspects of, the guided diffusion model described with reference to FIG. 10 and the U-Net described with reference to FIG. 11. In some embodiments, image processing apparatus 700 includes processor unit 705, I/O module 710, user interface 715, memory unit 720, machine learning model 725, and training component 760. Training component 760 updates parameters of the image generation model 755 stored in memory unit 720. In some examples, the training component 760 is located outside the image processing apparatus 700.

Processor unit 705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 705 is configured to operate a memory array using a memory controller. In other cases, a memory controller is integrated into processor unit 705. In some cases, processor unit 705 is configured to execute computer-readable instructions stored in memory unit 720 to perform various functions. In some aspects, processor unit 705 includes special-purpose components for modem processing, baseband processing, digital signal processing, or transmission processing. According to some aspects, processor unit 705 comprises one or more processors described with reference to FIG. 25.

Memory unit 720 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 705 to perform various functions described herein.

In some cases, memory unit 720 includes a basic input/output system (BIOS) that controls basic hardware or software operations, such as an interaction with peripheral components or devices. In some cases, memory unit 720 includes a memory controller that operates memory cells of memory unit 720. For example, the memory controller may include a row decoder, column decoder, or both. In some cases, memory cells within memory unit 720 store information in the form of a logical state. According to some aspects, memory unit 720 is an example of the memory subsystem 2510 described with reference to FIG. 25.

According to some aspects, image processing apparatus 700 uses one or more processors of processor unit 705 to execute instructions stored in memory unit 720 to perform functions described herein. For example, image processing apparatus 700 may obtain an input image and a modification input, wherein the input image depicts an object and the modification input indicates a change to a location of a part of the object. Image processing apparatus 700 generates a feature map representing the part of the object based on the input image. Image processing apparatus 700 transforming the feature map to obtain a transformed feature map based on the modification input, wherein the transformed feature map represents the change to the location of the part of the object. Image processing apparatus 700 generates, using image generation model 755, a synthetic image based on the input image and the transformed feature map, where the synthetic image depicts the change to the location of the part of the object.

The memory unit 720 may include a machine learning model 725 trained to obtain an input image and a modification input, wherein the input image depicts an object and the modification input indicates a change to a location of a part of the object; generate a feature map representing the part of the object based on the input image; transform the feature map to obtain a transformed feature map based on the modification input, wherein the transformed feature map represents the change to the location of the part of the object; and generate, using image generation model 755, a synthetic image based on the input image and the transformed feature map, wherein the synthetic image depicts the change to the location of the part of the object. For example, after training, machine learning model 725 may perform inferencing operations as described with reference to FIGS. 2, 6 and 15-19.

In some embodiments, the machine learning model 725 is an artificial neural network (ANN) comprising a guided diffusion model described with reference to FIG. 10 and the U-Net described with reference to FIG. 11. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted. In some examples, the nodes are aggregated into layers.

The parameters of machine learning model 725 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

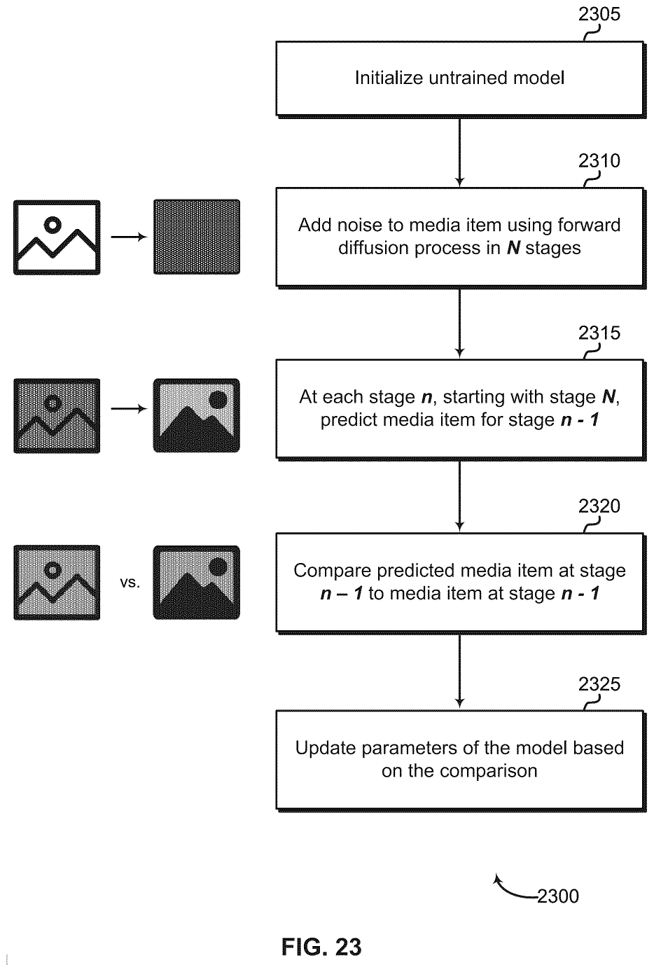

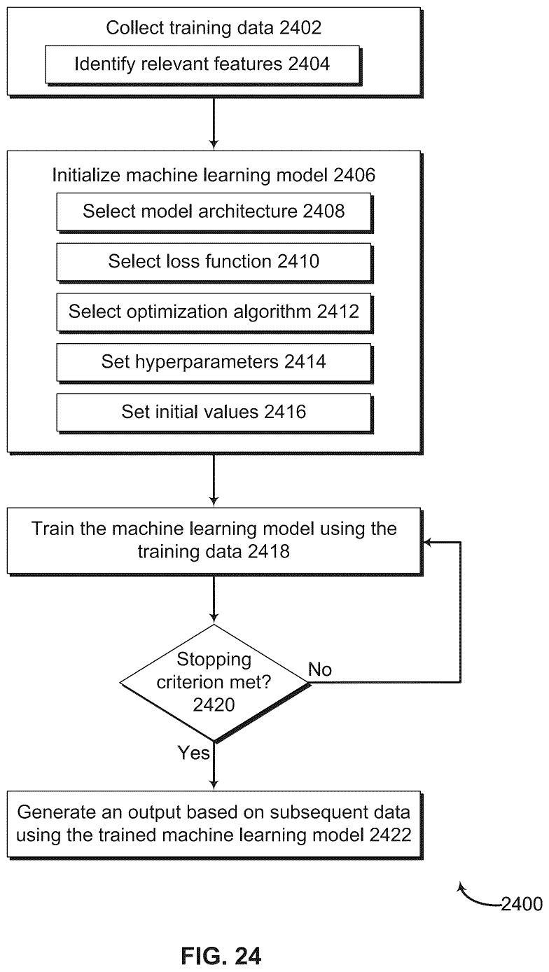

Training component 760 may train the machine learning model 725. For example, parameters of the machine learning model 725 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 23-24). The goal of the training process may involve finding optimal values for the parameters that allow the machine learning model to make accurate predictions or perform well on the given task.

Accordingly, the node weights can be adjusted to increase the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 725 can be used to make predictions on new, unseen data (i.e., during inference).

I/O module 710 receives inputs from and transmits outputs of the image processing apparatus 700 to other devices or users. For example, I/O module 710 receives inputs for the machine learning model 725 and transmits outputs of the machine learning model 725. According to some aspects, I/O module 710 is an example of the I/O interface 2520 described with reference to FIG. 25.

Machine learning model 725 is an example of, or includes aspects of, the corresponding element described with reference to FIGS. 8 and 9. In one embodiment, machine learning model 725 includes image segmentation model 730, image encoder 735, key points extraction model 740, transformation component 745, mask network 750, and image generation model 755. Image segmentation model 730 is an example of, or includes aspects of, the corresponding element described with reference to FIG. 8. Key points extraction model 740 is an example of, or includes aspects of, the corresponding element described with reference to FIG. 8.

According to some embodiments, user interface 715 identifies a handle point of the object. In some examples, user interface 715 receives a drag input that changes a location of the handle point.

According to some embodiments, machine learning model 725 obtains an input image and a modification input, where the input image depicts an object and the modification input indicates a change to a location of a part of the object. In some examples, machine learning model 725 generates a feature map representing the part of the object based on the input image. In some examples, machine learning model 725 determines the change to the location of the part of the object based on the drag input.

According to some embodiments, image segmentation model 730 obtains an image input and generates segmentation information related to the image. In some cases, image segmentation model 730 generates information pertaining to the location of various objects or boundaries in an image. In some cases, image segmentation model 730 identifies (and segments) one or more foreground objects and background out of the image.

According to some embodiments, image encoder 735 generates an object embedding representing the object based on the input image, where the synthetic image is generated based on the object embedding. Image encoder 735 is an example of, or includes aspects of, the corresponding element described with reference to FIGS. 8 and 9.

In some examples, key points extraction model 740 identifies a set of key points of the input image corresponding to the object, where the part of the object corresponds to one of the set of key points, and where the modification input changes a location of one or more of the set of key points.

In some examples, key points extraction model 740 extracts a set of key points from the training image. Key points extraction model 740 extracts a set of key points from the ground-truth image corresponding to the set of key points from the training image, where the feature map is generated based on the set of key points from the training image and the transformed feature map is based on the set of key points from the ground-truth image.

According to some embodiments, transformation component 745 transforms the feature map to obtain a transformed feature map based on the modification input, where the transformed feature map represents the change to the location of the part of the object. The transformation component 745 can be a neural network or an algorithmic computation component.

According to some embodiments, mask network 750 obtains an input mask indicating a location of the object. In some examples, mask network 750 masks the input image based on the input mask to obtain a masked image, where the synthetic image is generated based on the masked image. In some examples, mask network 750 generates an augmented mask based on the input mask and the modification input, where the synthetic image is generated based on the augmented mask. In some examples, mask network 750 generates an augmented mask based on an optical influence of the object, where the synthetic image is generated based on the augmented mask. An optical influence may include reflection, shadow, refraction, illumination, etc.

According to some embodiments, mask network 750 generates an augmented mask based on the training mask and a training modification, where the additional synthetic image is generated based on the augmented mask. In some examples, mask network 750 generates an augmented mask based on an optical influence, where the additional synthetic image is generated based on the augmented mask. Mask network 750 is an example of, or includes aspects of, the corresponding element described with reference to FIG. 8.

According to some embodiments, image generation model 755 generates a synthetic image based on the input image and the transformed feature map, where the synthetic image depicts the change to the location of the part of the object. In some examples, image generation model 755 obtains a noise map. Image generation model 755 generates control guidance based on the transformed feature map. Image generation model 755 denoises the noise map based on the input image and the control guidance. In some examples, the image generation model 755 includes a diffusion model and a control network.

In some embodiments, image generation model 755 is trained using a training set including a training image and a ground-truth image, where the training image depicts a training object and the ground-truth image depicts a change to a location of a part of the training object.

According to some embodiments, training component 760 obtains a training set including a training image and a ground-truth image, where the training image depicts an object and the ground-truth image depicts a change to a location of a part of the object. In some examples, training component 760 generates a feature map representing the part of the object based on the training image. Training component 760 trains, using the training set, image generation model 755 to generate a synthetic image based on the training image and the transformed feature map, where the synthetic image depicts the change to the location of the part of the object.

In some examples, training component 760 computes a diffusion loss based on the ground-truth image. Training component 760 updates parameters of the image generation model 755 stored in a non-transitory computer readable medium based on the diffusion loss. In some examples, training component 760 obtains an additional training set including a training background image, a training foreground image, and a training mask. Training component 760 trains the image generation model 755 to generate an additional synthetic image based on the additional training set.

FIG. 8 shows an example of a machine learning model 800 according to aspects of the present disclosure. The example shown includes machine learning model 800, target image 805, mask network 810, background image 815, source image 820, key points extraction model 825, first set of key points 830, second set of key points 835, image segmentation model 840, foreground image 845, image encoder 850, object embedding 855, transformed key points 860, control network 865, and diffusion model 870. Machine learning model 800 is an example of, or includes aspects of, the corresponding element described with reference to FIGS. 7 and 9.

FIG. 8 shows an example of a system of training machine learning model 800 to achieve dragging in a feedforward way. The machine learning model 800 may be referred to as a dragging model. By tracking the key points (e.g., first set of key points 830, second set of key points 835) on an object at different views, machine learning model 800 rearranges the object features, such that the rearrangement follows a target object's shape and/or viewpoint (e.g., the target object from target image 805). Similar to a mask guidance system described in FIG. 9, an object is cropped out of source image 820 and fed to image encoder 850 (such as DINO encoder) to extract object representations. The object may be augmented or captured from another viewpoint. Key-point tracking is conducted between the input object and ground truth object to determine how the key points are moved (e.g., dragged). Based on the movements, object features are swapped from the input location to ground-truth location, thus obtaining a swapped feature as the input to control network 865 (e.g., ControlNet). The swapped feature can carry appearance information of the input object but changed geometry towards the ground-truth object. At the same time, masked background is input to control network 865 to preserve the background information. Control network 865 is an example of, or includes aspects of, the corresponding element described with reference to FIG. 9.

Thus, in some embodiments, an affine transformation (e.g., a translation, rotation, or stretch operation) is applied to image features in an embedding space. The affine transformation may be applied algorithmically or using a neural network trained to apply an affine transformation. In some cases, image features are moved or swapped within the embedding space based on keypoint movements indicated by a user modification input. The modified features can then be used to generate a modified image that include the change indicated by the user.

In an embodiment, target image 805 (including a target object) is fed to mask network 810 to obtain background image 815. The background image 815 includes an input mask indicating a location of the target object. Mask network 810 masks the target image 805 based on the input mask to obtain a masked image (also referred to as background image 815). The unmasked portion of background image 815 represents the background of target image 805. Mask network 810 is an example of, or includes aspects of, the corresponding element described with reference to FIG. 7.

In some examples, key points extraction model 825 takes source image 820 as input and identifies a first set of key points 830 corresponding to an object in source image 820. In one example, the first set of key points 830 corresponds to a “bag” object. Key points extraction model 825 takes target image 805 as input and identifies a second set of key points 835 corresponding to the “bag” object having a different location, viewpoint, orientation, and/or pose (i.e., the target object in this example). Key points extraction model 825 is an example of, or includes aspects of, the corresponding element described with reference to FIG. 7. First set of key points 830 is an example of, or includes aspects of, the corresponding element described with reference to FIG. 5. Second set of key points 835 is an example of, or includes aspects of, the corresponding element described with reference to FIG. 5.

The source image 820 is fed to image segmentation model 840 to generate foreground image 845, which includes a foreground object from source image 820. The foreground image 845 is input to image encoder 850 to generate an object embedding 855. Image segmentation model 840 is an example of, or includes aspects of, the corresponding element described with reference to FIG. 7. Image encoder 850 is an example of, or includes aspects of, the corresponding element described with reference to FIGS. 7 and 9.

The background image 815, the transformed key points 860, and the object embedding 855 are input to control network 865. In some cases, control network 865 may be referred to as key-points-guided control network. The object embedding 855 and output from control network 865 are then fed to diffusion model 870. In a reverse diffusion process, a noisy image at timestep t (i.e., xₜ) is passed through diffusion model 870 to generate an intermediate image at timestep t−1 (i.e., xₜ₋₁). Diffusion model 870 is an example of, or includes aspects of, the corresponding element described with reference to FIG. 9.

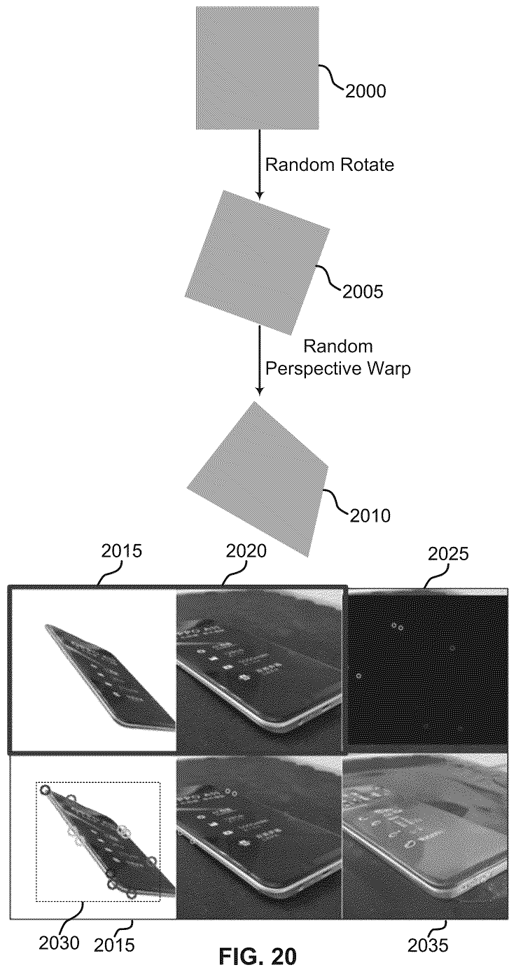

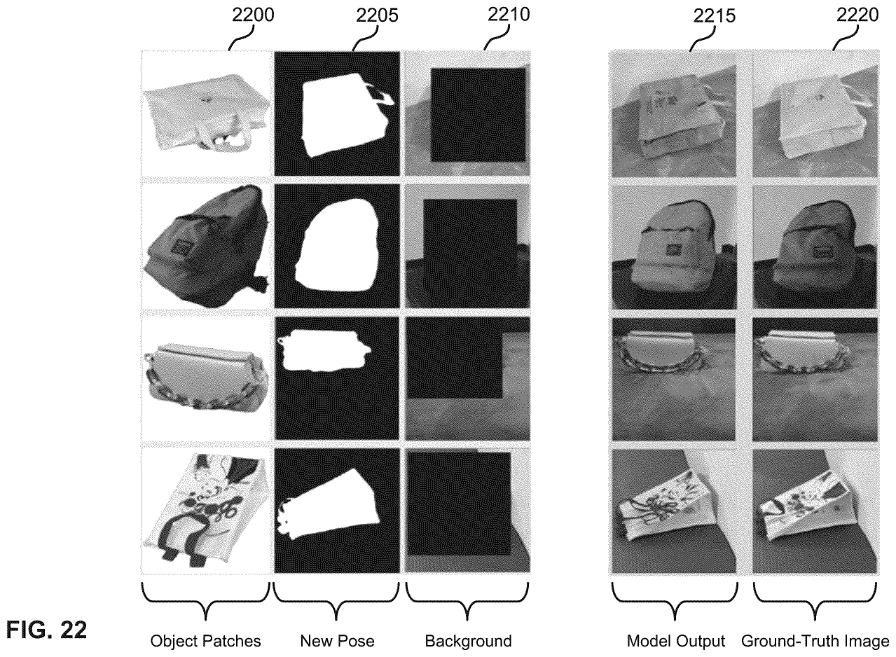

Target image 805 is an example of, or includes aspects of, the corresponding element described with reference to FIGS. 17-19. Background image 815 is an example of, or includes aspects of, the corresponding element described with reference to FIGS. 20 and 22. Foreground image 845 is an example of, or includes aspects of, the corresponding element described with reference to FIGS. 20 and 22. Object embedding 855 is an example of, or includes aspects of, the corresponding element described with reference to FIG. 9.

FIG. 9 shows an example of a machine learning model 900 according to aspects of the present disclosure. The example shown includes machine learning model 900, input image 905, image encoder 910, object embedding 915, input mask 920, control network 925, noisy image 930, masked image 935, diffusion model 945, and denoised image 950. In one aspect, masked image 935 includes augmented mask 940. Machine learning model 900 is an example of, or includes aspects of, the corresponding element described with reference to FIGS. 7 and 8.

FIG. 9 shows an example of a system for training machine learning model 900. The machine learning model 900 may be referred to as a mask guidance model. In some examples, image encoder 910 extracts image features from an input image 905. In some examples, image encoder 910 includes DINO image feature extractor. Mask guidance is realized by using a control network 925 (e.g., ControlNet). During training time, given an image, an object is randomly selected for editing. The object is segmented out and augmented as object input to image encoder 910. The original object mask is input to control network 925 as mask guidance. The guidance mask is in a different shape compared to the mask of the input object to image encoder 910. For the input image to the diffusion model 945 (e.g., U-Net), machine learning model 900 masks the union region of the guidance mask and the mask corresponding to the input object to image encoder 910. Thus, machine learning model 900 is trained to inpaint related regions. With control network guidance, diffusion model 945 synthesizes an object following the mask shape, while at the same time preserves the identity of the input object to image encoder 910. Image encoder 910 is an example of, or includes aspects of, the corresponding element described with reference to FIGS. 7 and 8. Control network 925 is an example of, or includes aspects of, the corresponding element described with reference to FIG. 8.

In an embodiment, input image 905 includes a foreground object (e.g., an apple) while the background of input image 905 is represented by white pixels. The input image 905 is input to image encoder 910 to generate an object embedding 915. An input mask 920 indicates a location of the object. The input mask 920 is fed to control network 925. Noisy image 930 (x, at timestep t), masked image 935, output from control network 925, and object embedding 915 are fed to diffusion model 945 as inputs. In a reverse diffusion process, the diffusion model 945 generates a denoised image 950 (e.g., an intermediate image xₜ₋₁ at timestep t−1. The masked image 935 includes augmented mask 940. Diffusion model 945 is an example of, or includes aspects of, the corresponding element described with reference to FIG. 8.

Input image 905 is an example of, or includes aspects of, the corresponding element described with reference to FIG. 3. Object embedding 915 is an example of, or includes aspects of, the corresponding element described with reference to FIG. 8. Augmented mask 940 is an example of, or includes aspects of, the corresponding element described with reference to FIGS. 17-19.

FIG. 10 shows an example of a guided diffusion model according to aspects of the present disclosure. The guided latent diffusion model 1000 depicted in FIG. 10 is an example of, or includes aspects of, the corresponding element (i.e., image generation model 755) described with reference to FIG. 7.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1000 may take an original image 1005 in a pixel space 1010 as input and apply and image encoder 1015 to convert original image 1005 into original image features 1020 in a latent space 1025. Then, a forward diffusion process 1030 gradually adds noise to the original image features 1020 to obtain noisy features 1035 (also in latent space 1025) at various noise levels.

Next, a reverse diffusion process 1040 (e.g., a U-Net ANN) gradually removes the noise from the noisy features 1035 at the various noise levels to obtain denoised image features 1045 in latent space 1025. In some examples, the denoised image features 1045 are compared to the original image features 1020 at each of the various noise levels, and parameters of the reverse diffusion process 1040 of the diffusion model are updated based on the comparison. Finally, an image decoder 1050 decodes the denoised image features 1045 to obtain an output image 1055 in pixel space 1010. In some cases, an output image 1055 is created at each of the various noise levels. The output image 1055 can be compared to the original image 1005 to train the reverse diffusion process 1040.

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 and fine-tuned jointly with the reverse diffusion process 1040.

The reverse diffusion process 1040 can also be guided based on a text prompt 1060, or another guidance prompt, such as an image, a layout, a segmentation map, etc. The text prompt 1060 can be encoded using a text encoder 1065 (e.g., a multimodal encoder) to obtain guidance features 1070 in guidance space 1075. The guidance features 1070 can be combined with the noisy features 1035 at one or more layers of the reverse diffusion process 1040 to ensure that the output image 1055 includes content described by the text prompt 1060. For example, guidance features 1070 can be combined with the noisy features 1035 using a cross-attention block within the reverse diffusion process 1040.

FIG. 11 shows an example of a U-Net 1100 architecture according to aspects of the present disclosure. In some examples, U-Net 1100 is an example of the component that performs the reverse diffusion process 1040 of guided latent diffusion model 1000 described with reference to FIG. 10 and includes architectural elements of the image generation model 755 described with reference to FIG. 7. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input features 1105 having an initial resolution and an initial number of channels and processes the input features 1105 using an initial neural network layer 1110 (e.g., a convolutional network layer) to produce intermediate features 1115. The intermediate features 1115 are then down-sampled using a down-sampling layer 1120 such that down-sampled features 1125 have a resolution less than the initial resolution and a number of channels greater than the initial number of channels.

This process is repeated multiple times, and then the process is reversed. That is, the down-sampled features 1125 are up-sampled using up-sampling process 1130 to obtain up-sampled features 1135. The up-sampled features 1135 can be combined with intermediate features 1115 having the same resolution and number of channels via a skip connection 1140. These inputs are processed using a final neural network layer 1145 to produce output features 1150. In some cases, the output features 1150 have the same resolution as the initial resolution and the same number of channels as the initial number of channels.

In some cases, U-Net 1100 takes additional input features to produce conditionally generated output. For example, the additional input features could include a vector representation of an input prompt. The additional input features can be combined with the intermediate features 1115 within the neural network at one or more layers. For example, a cross-attention module can be used to combine the additional input features and the intermediate features 1115.

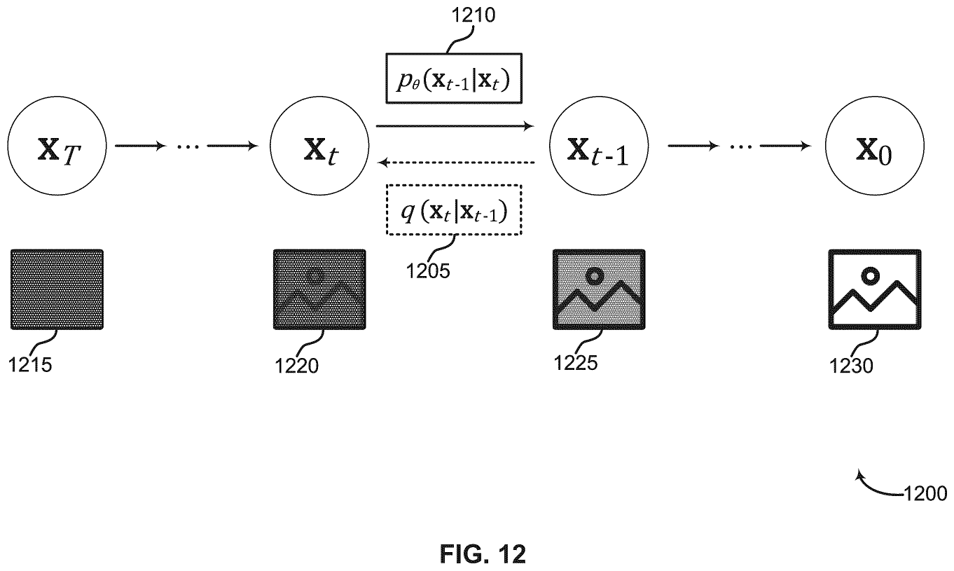

FIG. 12 shows an example of a diffusion process 1200 according to aspects of the present disclosure. In some examples, diffusion process 1200 describes an operation of the image generation model 755 described with reference to FIG. 7, such as the reverse diffusion process 1040 of guided latent diffusion model 1000 described with reference to FIG. 10.

As described above with reference to FIGS. 10 and 12, using a diffusion model can involve both a forward diffusion process 1205 for adding noise to a media item (or features in a latent space) and a reverse diffusion process 1210 for denoising the media item (or features) to obtain a denoised media item. The forward diffusion process 1205 can be represented as q(xₜ|xₜ₋₁), and the reverse diffusion process 1210 can be represented as p(xₜ₋₁|xₜ). In some cases, the forward diffusion process 1205 is used during training to generate media items with successively greater noise, and a neural network is trained to perform the reverse diffusion process 1210 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1210, the model begins with noisy data x_{T}, such as a noisy media item 1215 and denoises the data to obtain the p(xₜ₋₁|xₜ). At each step t−1, the reverse diffusion process 1210 takes xₜ, such as first intermediate media item 1220, and t as input. Here, t represents a step in the sequence of transitions associated with different noise levels, The reverse diffusion process 1210 outputs xₜ₋₁, such as second intermediate media item 1225 iteratively until x_{T} reverts back to x₀, the original media item 1230. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} \text{:} {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{y} represent noisy media items, and z represents the generated item with high quality.

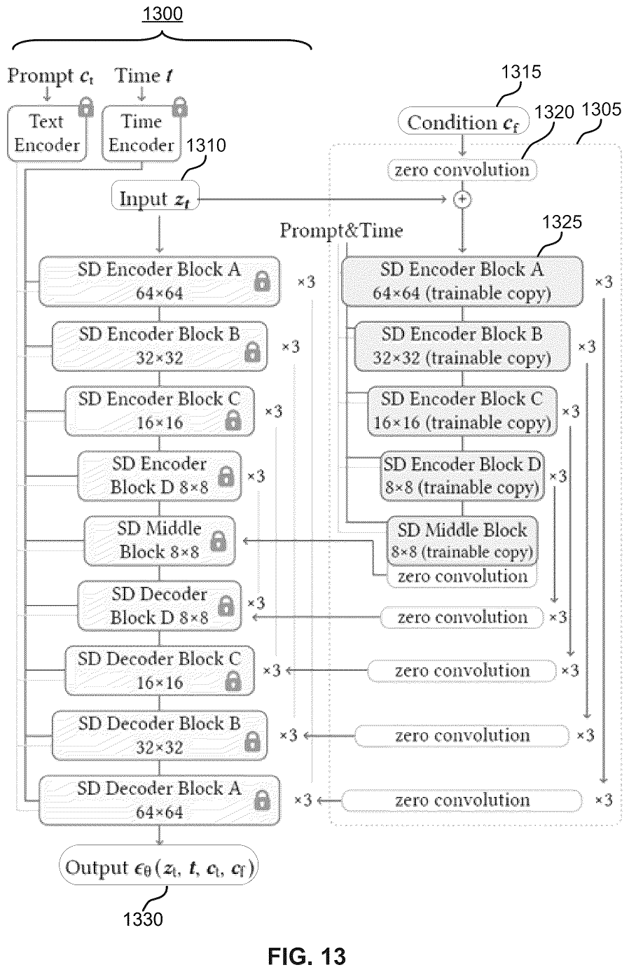

FIG. 13 shows an example of an image generation model comprising a control network according to aspects of the present disclosure. The example shown includes U-Net 1300, control network 1305, noisy image 1310, conditioning vector 1315, zero convolution layer 1320, trainable copy 1325, and learned network 1330.

ControlNet is a neural network structure configured to control image generation models by adding extra conditions. In some embodiments, a ControlNet architecture copies the weights from some of the neural network blocks of the image generation model to create a “locked” copy and a “trainable” copy 1325. The “trainable” one learns your condition. The “locked” copy preserves the parameters of the original model. The trainable copy 1325 can be tuned with a small dataset of image pairs, while preserving the locked copy ensures that original model is preserved.

As an example architecture shown in FIG. 13, the image generation model comprises U-Net 1300 (the left-hand side) and control network 1305 (the right-hand side). In some embodiments, a ControlNet architecture can be used to control a diffusion U-Net 1300 (i.e., to add controllable parameters or inputs that influence the output). Encoder layers of the U-Net 1300 can be copied and tuned. Then zero convolution layers can be added. The output of the control network 1305 can be input to decoder layers of the U-Net 1300.

In an embodiment, Stable Diffusion's U-Net is connected with a ControlNet on the encoder blocks and middle block. The locked blocks (light gray) show the structure of Stable Diffusion (U-Net architecture). The trainable copy blocks (dark gray) and the zero convolution layers are added to build a ControlNet. In some cases, trainable copy 1325 may be referred to as a trainable copy block or a trainable block.

In some embodiments, one or more zero convolution layers (e.g., zero convolution layer 1320) are added to the trainable copy 1325. A zero convolution layer 1320 is 1×1 convolution with both weight and bias initialized as zeros. Before training, the zero convolution layers output all zeros. Accordingly, the ControlNet does not cause any distortion. As the training proceeds, the parameters of the zero convolution layers deviate from zero and the influence of the ControlNet on the output grows.

Given an input image z₀, image diffusion algorithms progressively add noise to the image and produce a noisy image zₜ, where t represents the number of times noise is added. Given a set of conditions including time step t, text prompts cₜ, as well as a task-specific condition c_{f}, image diffusion algorithms learn a network ϵ_{θ} to predict the noise added to the noisy image zₜ with:

$$L = {E}_{{z}_{0} , t , {c}_{t} , {c}_{f} , ϵ ∼ N ( 0 , 1 )} [ {‖ ϵ - ϵ ( {z}_{t} , t , {c}_{t} , {c}_{f} ) ‖}_{2}^{2} ] \qquad ( 3 )$$

where L is the overall learning objective of the entire diffusion model. This learning objective is directly used in fine-tuning diffusion models with ControlNet. The output from U-Net 1300 includes parameters corresponding to learned network 1330, e.g., output ϵ_{θ}(zₜ, t, cₜ, c_{f}).

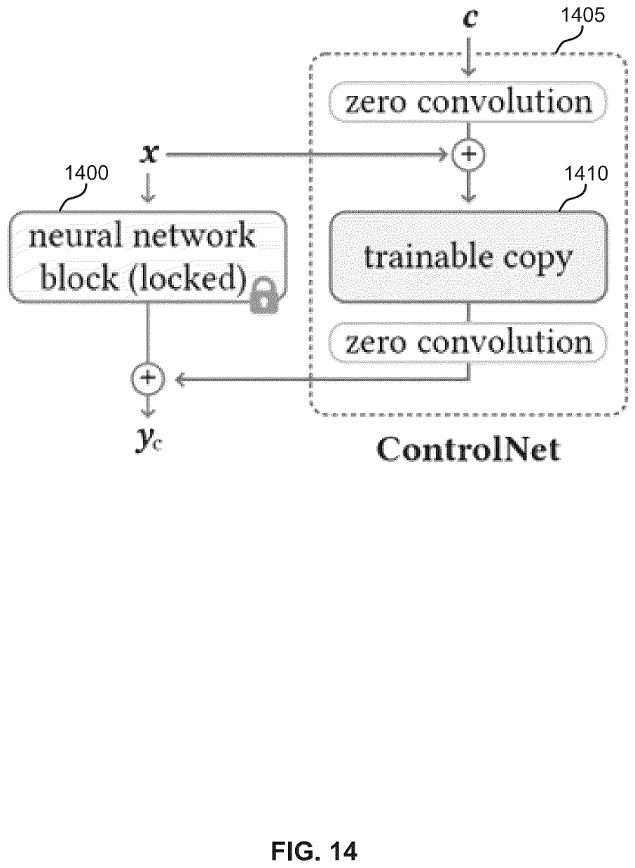

Control network 1305 is an example of, or includes aspects of, the corresponding element described with reference to FIGS. 7-9 and 14. Trainable copy 1325 is an example of, or includes aspects of, the corresponding element described with reference to FIG. 14.

FIG. 14 shows an example of a control network 1405 of an image generation model according to aspects of the present disclosure. The example shown includes neural network block 1400, control network 1405, and trainable copy 1410.

In some examples, a neural network block 1400 takes a feature map x as input and outputs another feature map y. To add a ControlNet (i.e., control network 1405) to such a block, some embodiments lock the original block and create a trainable copy 1410 and connect them together using zero convolution layers, i.e., 1×1 convolution with both weight and bias initialized to zero. Here c is a conditioning vector added to the network.

In an embodiment, Stable Diffusion's U-Net is connected with a ControlNet on the encoder blocks and middle block. The locked neural network block 1400 (light gray) shows a portion of the structure of Stable Diffusion (U-Net architecture). The trainable copy 1410 (dark gray) and the zero convolution layers are added to build a ControlNet. In some cases, trainable copy 1410 may be referred to as a trainable copy block or a trainable block.

Control network 1405 is an example of, or includes aspects of, the corresponding element described with reference to FIGS. 7-9 and 13. Trainable copy 1410 is an example of, or includes aspects of, the corresponding element described with reference to FIG. 13.

In FIGS. 7-14, an apparatus, system, and method for image generation are described. One or more embodiments of the apparatus, system, and method include a memory component; a processing device coupled to the memory component, where the processing device is configured to perform operations comprising: obtaining an input image and a modification input, wherein the input image depicts an object and the modification input indicates a change to the object; generating a feature map representing the object based on the input image; transforming the feature map to obtain a transformed feature map based on the modification input, wherein the transformed feature map represents the change to the object; and generating, using an image generation model, a synthetic image based on the input image and the transformed feature map, wherein the synthetic image depicts the change to the object.

In some examples, the image generation model comprises a diffusion model and a control network. Some examples of the apparatus, system, and method further include generating, using an image encoder, an object embedding representing the object based on the input image, wherein the synthetic image is generated based on the object embedding.

Some examples of the apparatus, system, and method further include obtaining an input mask indicating a location of the object. Some examples further include masking, using a masking network, the input image based on the input mask to obtain a masked image, wherein the synthetic image is generated based on the masked image.

Some examples of the apparatus, system, and method further include generating an augmented mask based on the input mask and on the modification input or an optical influence of the object, wherein the synthetic image is generated based on the augmented mask.

### Controlled Object Editing

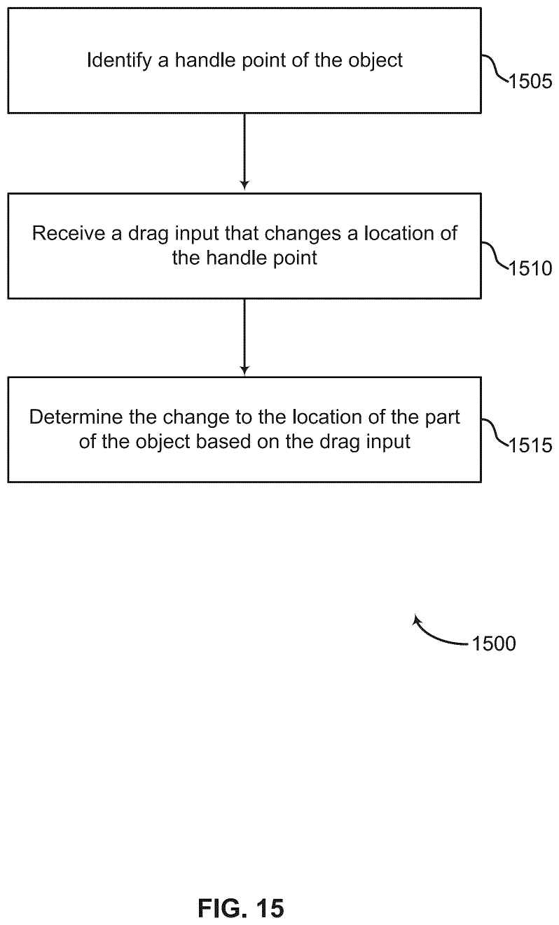

FIG. 15 shows an example of a method 1500 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1505, the system identifies a handle point of the object. In some cases, the operations of this step refer to, or may be performed by, a user interface as described with reference to FIG. 7. In some examples, a handle point is used to change a location of a part of the object based on a modification input or a drag command (e.g., a drag input). In some cases, a user may interact with one or more handle points associated with the object.

At operation 1510, the system receives a drag input that changes a location of the handle point. In some cases, the operations of this step refer to, or may be performed by, a user interface as described with reference to FIG. 7. In some cases, the drag input is applied to a handle point associated with the object, where the drag input indicates a direction and effect of a change of location to a part of the object. The effect of the change may include a magnitude such as a distance in the intended direction. In some cases, the drag input is given through a finger movement on a touch screen of an electronic device or a mouse click-and-drag.

At operation 1515, the system determines the change to the location of the part of the object based on the drag input. In some cases, the operations of this step refer to, or may be performed by, a machine learning model as described with reference to FIGS. 7-9. In some examples, a change to the location of the part of the object involves resizing, moving, relocating, or scaling a part of the object.

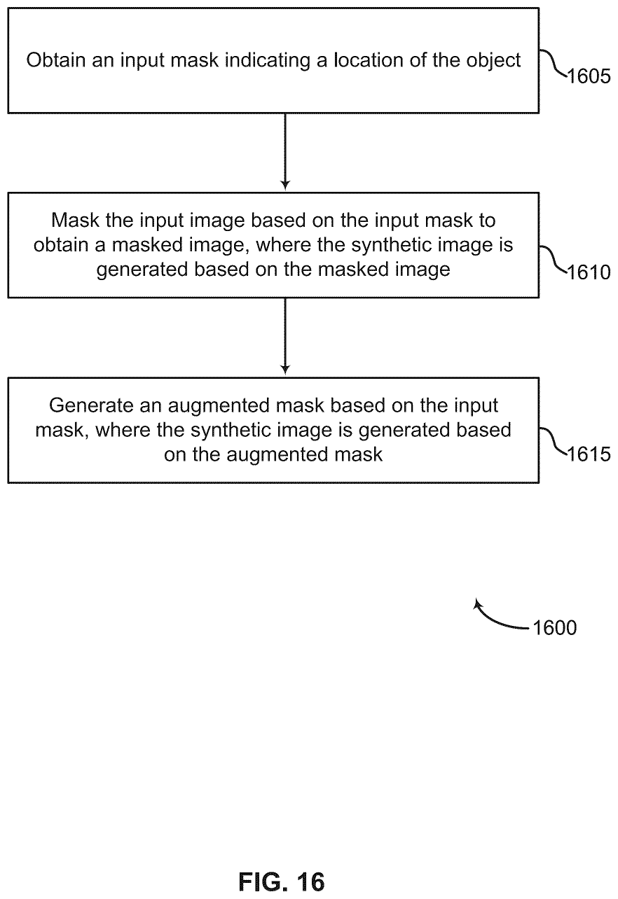

FIG. 16 shows an example of a method 1600 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1605, the system obtains an input mask indicating a location of the object. In some cases, the operations of this step refer to, or may be performed by, a mask network as described with reference to FIGS. 7 and 8.

At operation 1610, the system masks the input image based on the input mask to obtain a masked image, where the synthetic image is generated based on the masked image. In some cases, the operations of this step refer to, or may be performed by, a mask network as described with reference to FIGS. 7 and 8. In some cases, the masked image indicates an inpainting region for an image generation model to synthesize (e.g., fill in the masked area).

At operation 1615, the system generates an augmented mask based on the input mask (and in some cases the modification input), where the synthetic image is generated based on the augmented mask. In some cases, the operations of this step refer to, or may be performed by, a mask network as described with reference to FIGS. 7 and 8. The augmented mask is viewed as a combination of the input mask and a target mask. The target mask corresponds to an augmented object (e.g., a target object from an input image). An example of generating an augmented mask via merging can be found in FIGS. 17-19.

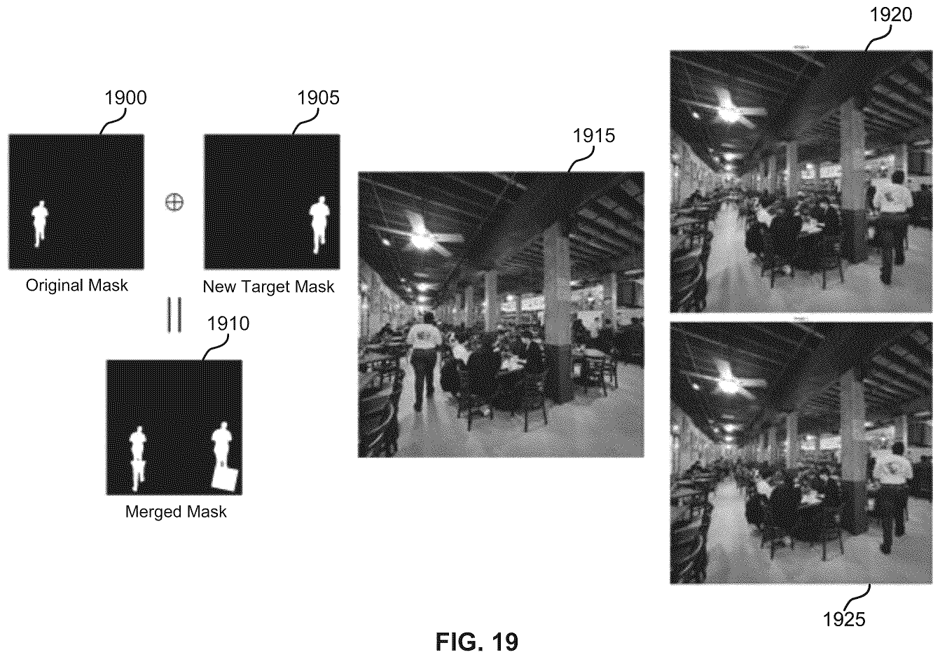

In some examples, the augmented mask indicates a larger area than the input mask. In some examples, the augmented mask includes additional area to be masked to generate a visually consistent synthetic image. For example, the augmented mask includes an area that should have different shadows than the input image because of a differently positioned/located object. That is, the augmented mask expands the area which the image generation model will inpaint so that the model can add or remove shadows related to a modified object. When a person is removed or relocated, the original shadow of the person should be removed or changed as well. An example of using an augmented mask to add/remove shadows is described with reference to FIG. 19.

FIG. 17 shows an example of masks and synthetic images 1725 according to aspects of the present disclosure. The example shown includes original mask 1700, target mask 1705, augmented mask 1710, original image 1715, target image 1720, and synthetic image 1725.

As illustrated in FIG. 17, a mask network described in FIG. 7 takes an input image and generates an original mask 1700 (depicting a location of an object as shown in original image 1715). A target mask 1705 depicts a target location of the object as shown in target image 1720). The original mask 1700 and target mask 1705 are merged or combined to obtain an augmented mask 1710. In some cases, augmented mask 1710 is also referred to as a merged mask. The augmented mask 1710 is viewed as a combination of the original mask 1700 and the target mask 1705.

A machine learning model (as described with reference to FIGS. 7-9) takes an original image 1715 and the augmented mask 1710 as inputs and generates synthetic image 1725 based on the augmented mask 1710. The augmented mask 1710 includes the area of the object in the original image 1715 and the target location for the object in the target image 1720, so the machine learning model fills in the masked space and generates a visually consistent synthetic image 1725. For comparison, target image 1720 depicts the intended image. The synthetic image 1725 depicts a visually similar image (a shoe on a concrete floor) compared to target image 1720.

In an example shown in FIG. 17, the machine learning model handles moving and resizing of the shoe object (target mask 1705 represents a resized shoe object, smaller in size compared to what original mask 1700 represents). Additionally, the machine learning model generates shadow in synthetic image 1725.

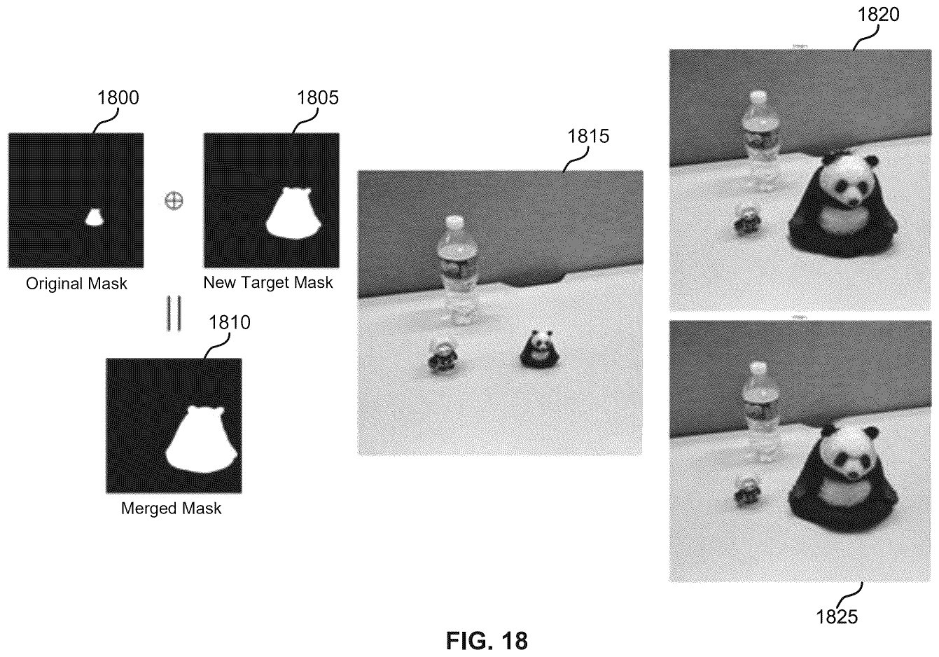

Original mask 1700 is an example of, or includes aspects of, the corresponding element described with reference to FIGS. 18 and 19. Target mask 1705 is an example of, or includes aspects of, the corresponding element described with reference to FIGS. 18 and 19. Augmented mask 1710 is an example of, or includes aspects of, the corresponding element described with reference to FIGS. 9, 18, and 19. Original image 1715 is an example of, or includes aspects of, the corresponding element described with reference to FIGS. 18-20. Target image 1720 is an example of, or includes aspects of, the corresponding element described with reference to FIGS. 8, 18, and 19. Synthetic image 1725 is an example of, or includes aspects of, the corresponding element described with reference to FIGS. 3, 18, 19, and 22.

FIG. 18 shows an example of masks and synthetic images 1825 according to aspects of the present disclosure. The example shown includes original mask 1800, target mask 1805, augmented mask 1810, original image 1815, target image 1820, and synthetic image 1825.

In an example shown in FIG. 18, a mask network described in FIG. 7 takes an original image 1815 and generates an original mask 1800 (depicting a location of a “panda” object in an input image). A target mask 1805 depicts a target location of the object. The original mask 1800 and the target mask 1805 are combined to obtain an augmented mask 1810. In some cases, the augmented mask 1810 is also referred to as a merged mask. A machine learning model (as described with reference to FIGS. 7-9) takes original image 1815 and the augmented mask 1810 as inputs and generates synthetic image 1825. Target image 1820 depicts the intended image. The synthetic image 1825 is visually similar to target image 1820 (e.g., similar background, similar panda object). The machine learning model relocates or resizes objects and then synthesizes a visually consistent image. Target mask 1805 is an example of, or includes aspects of, the corresponding element described with reference to FIGS. 17 and 19. Augmented mask 1810 is an example of, or includes aspects of, the corresponding element described with reference to FIGS. 9, 17, and 19.

In this example, original image 1815 includes a toy “panda” object positioned on a table. A water bottle and another toy are located next to the toy panda. Original mask 1800 indicates shape information and location information corresponding to the toy panda. Target mask 1805 shows a larger mask in the shape of the panda object corresponding to scale and size of the panda object in target image 1820. The white area in target mask 1805 is relatively large than the white area in original mask 1800. Augmented mask 1810 is viewed as a combination of original mask 1800 and target mask 1805. The synthetic image 1825 depicts the same panda object which is resized/rescaled match with augmented mask 1810. The synthetic image 1825 looks visually similar to target image 1820 (e.g., preserving object identity, maintaining background information).

In an example shown in FIG. 18, the machine learning model handles resizing of the panda object (target mask 1805 represents a resized panda object, larger in size compared to what original mask 1800 represents). Additionally, the machine learning model preserves the identity of unseen object(s) in synthetic image 1825. For example, identity of unseen object(s) such as a water bottle and a toy figure are preserved in synthetic image 1825.

Original mask 1800 is an example of, or includes aspects of, the corresponding element described with reference to FIGS. 17 and 19. Original image 1815 is an example of, or includes aspects of, the corresponding element described with reference to FIGS. 17, 19, and 20. Target image 1820 is an example of, or includes aspects of, the corresponding element described with reference to FIGS. 8, 17, and 19. Synthetic image 1825 is an example of, or includes aspects of, the corresponding element described with reference to FIGS. 3, 17, 19, and 22.

FIG. 19 shows an example of masks and synthetic images 1925 according to aspects of the present disclosure. The example shown includes original mask 1900, target mask 1905, augmented mask 1910, original image 1915, target image 1920, and synthetic image 1925.

In an embodiment, a mask network described in FIG. 7 takes original image 1915 as input and generates original mask 1900 based on the original image 1915. The original mask 1900 depicts a location of a “person” object in original image 1915. The target mask 1905 depicts a target location of the object in the target image 1920. The original mask 1900 and target mask 1905 are combined to obtain an augmented mask 1910. A machine learning model (as described with reference to FIGS. 7-9) takes an original image 1915 and the augmented mask 1910 and generates synthetic image 1925. Synthetic image 1925 is visually similar to target image 1920. Target mask 1905 is an example of, or includes aspects of, the corresponding element described with reference to FIGS. 17 and 18. Augmented mask 1910 is an example of, or includes aspects of, the corresponding element described with reference to FIGS. 9, 17, and 18.

In this example, original image 1915 depicts a person object in a restaurant scene. The original mask 1900 includes shape information, scale information, and location information corresponding to the person in the original image 1915. Target mask 1905 includes shape, scale, and location information of the same person in the restaurant (as shown in target image 1920). The person object of target image 1920 is located on the right-hand side, different from the person's location in original image 1915 (i.e. the left side). The augmented mask 1910 is viewed as a combination of original mask 1900 and target mask 1905. A machine learning model (described with reference to FIGS. 7-9) takes original image 1915 and augmented mask 1910 as inputs and generates synthetic image 1925. In synthetic image 1925, the person is also located on the right-hand side in the scene, similar to target image 1920. Shadows on the floor on the left-hand side are removed. Shadows are generated on the right-hand side in synthetic image 1925 according to the augmented mask 1910. The synthetic image 1925 looks visually similar to target image 1920 (e.g., preserving object identity, maintaining background information).

In an example shown in FIG. 19, the machine learning model handles moving of a person object from a first location to a second location. The original mask 1900 represents the person object at the first location. The target mask 1905 represents the person object at the second location different from the first location, Additionally, the machine learning model removes the original shadow associated with the person object at the first location in synthetic image 1925.

Original mask 1900 is an example of, or includes aspects of, the corresponding element described with reference to FIGS. 17 and 18. Original image 1915 is an example of, or includes aspects of, the corresponding element described with reference to FIGS. 17, 18, and 20. Target image 1920 is an example of, or includes aspects of, the corresponding element described with reference to FIGS. 8, 17, and 18. Synthetic image 1925 is an example of, or includes aspects of, the corresponding element described with reference to FIGS. 3, 17, 18, and 22.

FIG. 20 shows an example of an image modification according to aspects of the present disclosure. The example shown includes original image 2000, rotated image 2005, warped image 2010, foreground image 2015, input image 2020, masked image 2025, key points 2030, and synthetic image 2035.

In an example shown in FIG. 20, an original image 2000 is randomly rotated to obtain a rotated image 2005. The rotated image 2005 is then modified (e.g., using random perspective warp) to obtain warped image 2010. A foreground image 2015 includes a “phone” object. An input image 2020 includes a same phone which has a different pose and orientation compared to foreground image 2015. A masked image 2025 provides background information and in some cases may be referred to as a masked background image. A set of key points 2030 are identified in foreground image 2015 (represented by a set of small circles).

FIG. 20 shows an example of a data generation process. Input image 2020 (i.e., original), foreground image 2015, and masked image 2025 are fed to an image generation model. The foreground image 2015 includes an augmented object image and source positions of a set of key points, the augmented object image is generated using random rotation and perspective warp (from original image 2000 to rotated image 2005, from rotated image 2005 to warped image 2010). The masked image 2025 includes target positions of key points (represented by a set of small circles in FIG. 20) and the background region, while the object area is masked out.

Original image 2000 is an example of, or includes aspects of, the corresponding element described with reference to FIGS. 17-19. Foreground image 2015 is an example of, or includes aspects of, the corresponding element described with reference to FIGS. 8 and 22. Masked image 2025 is an example of, or includes aspects of, the corresponding element described with reference to FIGS. 8 and 22.

FIG. 21 shows an example of a method 2100 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2105, the system obtains a training set including a training image and a ground-truth image, where the training image depicts an object and the ground-truth image depicts a change to a location of a part of the object. In some cases, the operations of this step refer to, or may be performed by, a training component as described with reference to FIG. 7.

In some cases, obtaining a training set can include creating training data for training a machine learning model (e.g., an image generation model). In some cases, the system obtains a pre-existing training set.

In some examples, unsupervised learning is used to train a diffusion model that achieves object manipulation by mask editing and local dragging. The mask editing process includes resizing, moving, and rotation, which can be done by a single click from a user. The local dragging targets local editing of an object, i.e., changing object internal structure.

Given an image, an object is segmented out using an image segmentation model 730 described in FIG. 7. The segmented object may be referred to as a foreground object. The object is an object of interest to be edited. A corresponding mask is generated based on the object, which is used as editing guidance. The object is cropped out of the image and augmentations such as rotation or perspective modification are applied to the object. This way, the system creates a training pair of input object/background and a ground-truth image. For dragging, the system uniformly and exclusively extracts one or more key points in the object region, and then warps the object together with the selected points to synthesize training data.

At operation 2110, the system generates a feature map representing the part of the object based on the training image. In some cases, the operations of this step refer to, or may be performed by, a training component as described with reference to FIG. 7.

At operation 2115, the system transforms the feature map to obtain a transformed feature map, where the transformed feature map represents the change to the location of the part of the object. In some cases, the operations of this step refer to, or may be performed by, a transformation component as described with reference to FIG. 7.

At operation 2120, the system trains, using the training set, an image generation model to generate a synthetic image based on the training image and the transformed feature map, where the synthetic image depicts the change to the location of the part of the object. In some cases, the operations of this step refer to, or may be performed by, a training component as described with reference to FIG. 7.

In some examples, the machine learning model is initialized using random values. In other examples, the machine learning model is initialized based on a pre-trained model.

In some embodiments, the machine learning model 800 (with reference to FIG. 8) and machine learning model 900 (with reference to FIG. 9) may share the network structure but these models are trained with different datasets (inputs). The machine learning model 800 may be referred to as a dragging model (e.g., user-specified dragging/command to change the shape or internal structure of an object). The machine learning model 900 may be referred to as a mask guidance model. The mask guidance model and dragging model can be trained in a unified framework, which simultaneously achieve mask and dragging control.

FIG. 22 shows an example of a training dataset according to aspects of the present disclosure. The example shown includes foreground image 2200, training mask 2205, background image 2210, synthetic image 2215, and ground-truth image 2220. In an embodiment, a machine learning model (as described with reference to FIGS. 7-9) takes a foreground image 2200, a training mask 2205, and a background image 2210 as inputs and generate a synthetic image 2215. The synthetic image 2215 (a model output) is compared to a ground-truth image 2220 and parameters of the machine learning model are updated based on the comparison. The synthetic image 2215 depicts a same object from foreground image 2200 having the location, pose, scale, and orientation as specified in training mask 2205. The object in the scene of background image 2210.

For example, foreground image 2200 includes a “bag” object, training mask 2205 has a similar shape according to the bag but the pose and orientation of the bag is changed (e.g., the bag in training mask 2205 is rotated). In training mask 2205, the handle of the bag points to the right instead of pointing downwards. The background image 2210 provides a scene having floor and wall. The synthetic image 2215 depicts the bag in the position and orientation specified in training mask 2205 in the same scene as in background image 2210.

Foreground image 2200 is an example of, or includes aspects of, the corresponding element described with reference to FIGS. 8 and 20. Background image 2210 is an example of, or includes aspects of, the corresponding element described with reference to FIGS. 8 and 20. Synthetic image 2215 is an example of, or includes aspects of, the corresponding element described with reference to FIGS. 3, and 17-19.

FIG. 23 shows an example of a method 2300 for training a diffusion model according to aspects of the present disclosure. In some embodiments, the method 2300 describes an operation of the training component 760 described for configuring the image generation model 755 as described with reference to FIG. 7. The method 2300 represents an example for training a reverse diffusion process as described above with reference to FIGS. 10 and 12. In some examples, these operations are performed by a system including a processor executing a set of codes to control functional elements of an apparatus, such as the guided latent diffusion model described in FIG. 10.

Additionally or alternatively, certain processes of method 2300 may be performed using special-purpose hardware. Generally, these operations are performed according to the methods and processes described in accordance with aspects of the present disclosure. In some cases, the operations described herein are composed of various substeps or are performed in conjunction with other operations.

At operation 2305, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

At operation 2310, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2320, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2325, the system updates parameters of the model based on the comparison. For example, parameters of a U-Net may be updated using gradient descent. Time-dependent parameters of the Gaussian transitions can also be learned.

FIG. 24 shows an example of a step-by-step procedure 2400 for training a machine learning model according to aspects of the present disclosure. FIG. 24 shows a flow diagram depicting an algorithm as a step-by-step procedure 2400 in an example implementation of operations performable for training a machine-learning model. In some embodiments, the procedure 2400 describes an operation of the training component 760 described for configuring the image generation model 755 as described with reference to FIG. 7. The procedure 2400 provides one or more examples of generating training data, use of the training data to train a machine learning model, and use of the trained machine learning model to perform a task.

To begin in this example, a machine-learning system collects training data (block 2402) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2406). Initialization of the machine-learning model includes selecting a model architecture (block 2408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2410). The loss function is utilized to measure a difference between an output of the machine-learning model (i.e., predictions) and target values (e.g., as expressed by the training data) to be used to train the machine-learning model. Additionally, an optimization algorithm is selected (2412) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2414) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2420), i.e., which is used to validate the machine-learning model. The stopping criterion is usable to reduce overfitting of the machine-learning model, reduce computational resource consumption, and promote an ability of the machine-learning model to address previously unseen data, i.e., data that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2420), the procedure 2400 continues training of the machine-learning model using the training data (block 2418) in this example.

If the stopping criterion is met (“yes” from decision block 2420), the trained machine-learning model is then utilized to generate an output based on subsequent data (block 2422). The trained machine-learning model, for instance, is trained to perform a task as described above and therefore, once trained is configured to perform that task based on subsequent data received as an input and processed by the machine-learning model.

In FIGS. 21-24, a method, apparatus, non-transitory computer readable medium, and system for image generation are described. One or more embodiments of the method, apparatus, non-transitory computer readable medium, and system include obtaining a training set including a training image and a ground-truth image, wherein the training image depicts an object and the ground-truth image depicts a change to the object; generating a feature map representing the object based on the training image; transforming the feature map to obtain a transformed feature map, wherein the transformed feature map represents the change to the object; and training, using the training set, an image generation model to generate a synthetic image based on the training image and the transformed feature map, wherein the synthetic image depicts the change to the object.

Some examples of the method, apparatus, non-transitory computer readable medium, and system further include extracting a plurality of key points from the training image. Some examples further include extracting a plurality of key points from the ground-truth image corresponding to the plurality of key points from the training image, wherein the feature map is generated based on the plurality of key points from the training image and the transformed feature map is based on the plurality of key points from the ground-truth image.

Some examples of the method, apparatus, non-transitory computer readable medium, and system further include computing a diffusion loss based on the ground-truth image. Some examples further include updating parameters of the image generation model stored in a non-transitory computer readable medium based on the diffusion loss.

Some examples of the method, apparatus, non-transitory computer readable medium, and system further include obtaining an additional training set including a training background image, a training foreground image, and a training mask. Some examples further include training the image generation model to generate an additional synthetic image based on the additional training set.

Some examples of the method, apparatus, non-transitory computer readable medium, and system further include generating an augmented mask based on the training mask and a training modification, wherein the additional synthetic image is generated based on the augmented mask.

Some examples of the method, apparatus, non-transitory computer readable medium, and system further include generating an augmented mask based on an optical influence, wherein the additional synthetic image is generated based on the augmented mask.

FIG. 25 shows an example of a computing device 2500 for image processing according to aspects of the present disclosure. The computing device 2500 may be an example of the image processing apparatus 700 described with reference to FIG. 7. In one aspect, computing device 2500 includes processor(s) 2505, memory subsystem 2510, communication interface 2515, I/O interface 2520, user interface component(s) 2525, and channel 2530.

In some embodiments, computing device 2500 is an example of, or includes aspects of, the machine learning model 725 of FIG. 7. In some embodiments, computing device 2500 includes one or more processors 2505 that can execute instructions stored in memory subsystem 2510 to perform media generation.

According to some aspects, computing device 2500 includes one or more processors 2505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2515 operates at a boundary between communicating entities (such as computing device 2500, one or more user devices, a cloud, and one or more databases) and channel 2530 and can record and process communications. In some cases, communication interface 2515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2520 is controlled by an I/O controller to manage input and output signals for computing device 2500. In some cases, I/O interface 2520 manages peripherals not integrated into computing device 2500. In some cases, I/O interface 2520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2520 or via hardware components controlled by the I/O controller.

According to some aspects, user interface component(s) 2525 enable a user to interact with computing device 2500. In some cases, user interface component(s) 2525 include an audio device, such as an external speaker system, an external display device such as a display screen, an input device (e.g., a remote-control device interfaced with a user interface directly or through the I/O controller), or a combination thereof. In some cases, user interface component(s) 2525 include a GUI.

Performance of apparatus, systems and methods of the present disclosure have been evaluated, and results indicate embodiments of the present disclosure have obtained increased performance over existing technology. Example experiments demonstrate that the image processing apparatus described in embodiments of the present disclosure outperforms conventional systems. Unlike conventional models, embodiments of the present disclosure target a feedforward (no inference-time optimization) method and machine learning model instead of online optimization. This way, it speeds up the inference, and the model has increased efficiency.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a modification input, wherein the input image depicts an object and the modification input indicates a change to the object;
generating a feature map representing the object based on the input image;
transforming the feature map to obtain a transformed feature map based on the modification input, wherein the transformed feature map represents the change to the object; and
generating, using an image generation model, a synthetic image based on the input image and the transformed feature map, wherein the synthetic image depicts the change to the object.

2. The method of claim 1, wherein obtaining the modification input comprises:
identifying a handle point of the object;
receiving a drag input that changes a location of the handle point; and
determining the change to the object based on the drag input.

3. The method of claim 1, further comprising:
generating an object embedding representing the object based on the input image, wherein the synthetic image is generated based on the object embedding.

4. The method of claim 1, further comprising:
obtaining an input mask indicating a location of the object; and
masking the input image based on the input mask to obtain a masked image, wherein the synthetic image is generated based on the masked image.

5. The method of claim 4, further comprising:
generating an augmented mask based on the input mask and the modification input, wherein the synthetic image is generated based on the augmented mask.

6. The method of claim 1, further comprising:
generating an augmented mask based on an optical influence of the object, wherein the synthetic image is generated based on the augmented mask.

7. The method of claim 1, wherein generating the synthetic image comprises:
obtaining a noise map;
generating control guidance based on the transformed feature map; and
denoising the noise map based on the input image and the control guidance.

8. The method of claim 1, further comprising:
identifying a plurality of key points of the input image corresponding to the object, wherein the modification input changes a location of the plurality of key points.

9. The method of claim 1, wherein:
the image generation model is trained using a training set including a training image and a ground-truth image, wherein the training image depicts a training object and the ground-truth image depicts a change to the training object.

10. A method of training an image generation model, the method comprising:
obtaining a training set including a training image and a ground-truth image, wherein the training image depicts an object and the ground-truth image depicts a change to the object;
generating a feature map representing the object based on the training image;
transforming the feature map to obtain a transformed feature map, wherein the transformed feature map represents the change to the object; and
training, using the training set, an image generation model to generate a synthetic image based on the training image and the transformed feature map, wherein the synthetic image depicts the change to the object.

11. The method of claim 10, further comprising:
extracting a plurality of key points from the training image; and
extracting a plurality of key points from the ground-truth image corresponding to the plurality of key points from the training image, wherein the feature map is generated based on the plurality of key points from the training image and the transformed feature map is based on the plurality of key points from the ground-truth image.

12. The method of claim 10, wherein training the image generation model comprises:
computing a diffusion loss based on the ground-truth image; and
updating parameters of the image generation model stored in a non-transitory computer readable medium based on the diffusion loss.

13. The method of claim 10, further comprising:
obtaining an additional training set including a training background image, a training foreground image, and a training mask; and
training the image generation model to generate an additional synthetic image based on the additional training set.

14. The method of claim 13, further comprising:
generating an augmented mask based on the training mask and a training modification, wherein the additional synthetic image is generated based on the augmented mask.

15. The method of claim 13, further comprising:
generating an augmented mask based on an optical influence, wherein the additional synthetic image is generated based on the augmented mask.

16. A system comprising:
a memory component; and
a processing device coupled to the memory component, the processing device configured to perform operations comprising:
obtaining an input image and a modification input, wherein the input image depicts an object and the modification input indicates a change to the object;
generating a feature map representing the object based on the input image;
transforming the feature map to obtain a transformed feature map based on the modification input, wherein the transformed feature map represents the change to the object; and
generating, using an image generation model, a synthetic image based on the input image and the transformed feature map, wherein the synthetic image depicts the change to the object.

17. The system of claim 16, wherein:
the image generation model comprises a diffusion model and a control network.

18. The system of claim 16, wherein the processing device is further configured to perform operations comprising:
generating, using an image encoder, an object embedding representing the object based on the input image, wherein the synthetic image is generated based on the object embedding.

19. The system of claim 16, wherein the processing device is further configured to perform operations comprising:
obtaining an input mask indicating a location of the object; and
masking, using a mask network, the input image based on the input mask to obtain a masked image, wherein the synthetic image is generated based on the masked image.

20. The system of claim 19, wherein the processing device is further configured to perform operations comprising:
generating an augmented mask based on the input mask and on the modification input or an optical influence of the object, wherein the synthetic image is generated based on the augmented mask.
